(19) United States
(12) Patent Application Publication
(10) Pub. No.: US 2017/0359696 A1
(43) Pub. Date: Dec. 14, 2017

(54) COMMUNICATION METHOD

(71) Applicant: NEC Corporation, Tokyo (JP)

(72) Inventors: Masato YASUDA, Tokyo (JP); Kazuaki NAKAJIMA, Tokyo (JP); Hidenori TSUKAHARA, Tokyo (JP)

(73) Assignee: NEC Corporation, Tokyo (JP)

(21) Appl. No.: 15/538,255

(22) PCT Filed: Nov. 9, 2015
(86) PCT No.: PCT/JP2015/005580

§ 371 Date: Jun. 21, 2017

(30) Foreign Application Priority Data
Dec. 26, 2014 (JP) 2014-264496

(51) Int. Cl. H04W 4/02; H04W 4/08; H04W 84/18; H04W 92/18

(52) U.S. Cl. CPC H04W 4/028; H04W 92/18; H04W 4/08; H04W 84/18; H04W 4/027

(57) ABSTRACT

A wireless communication network includes a plurality of nodes each capable of performing wireless communication by a first communication method that can form P2P group and wireless communication by a second communication method. A first owner node that operates as an access point to a first P2P group uses the wireless communication by the second communication method to discover a second P2P group present in a second communicable range that is a region outside a first communicable range defined by the first communication method, predicts the time that elapses before the second P2P group moves into the first communicable range, and performs group reorganization before the predicted time elapses.

### TECHNICAL FIELD

The present invention relates to a wireless terminal (Peer-to-Peer (hereinafter, referred to as “P2P”) terminal) mutually wirelessly connectable by P2P, communication control method and program therefor, a communication method, and a communication system.

### BACKGROUND ART

Over recent years, from the viewpoint of band widening, security enhancement, and the like, attention has been focused on Wi-Fi Direct as an inter-terminal communication method. A previous Wi-Fi network has been operated in an infrastructure mode in which a specific device is used as an access point (AP). On the other hand, a network conforming to Wi-Fi Direct allows any P2P terminal to become a Group Owner instead of a specific device, and thereby makes it possible to communicate in a group thereof (see NPL 1, for example). The Group Owner is a P2P terminal operating as an access point of a group and is capable of forming, as a parent of the group, a group including another P2P terminal as a child (client).

In the P2P group formed in this manner, it is possible to share data among terminals without connecting to the Internet or the like, and transfer data at high speed. In particular, in Wi-Fi Direct, a robust security protocol is supported and therefore higher security can be achieved compared to the security in a conventional ad hoc mode (IBSS: Independent Basic Service Set, or the like).

### CITATION LIST

### Non Patent Literature

NPL 1: Wi-Fi Alliance Technical Committee PSP Tack Group, Wi-Fi Peer-to-Peer (P2P) Technical Specification Version 1.1

### SUMMARY OF INVENTION

### Technical Problem

However, in the above-described wireless P2P network, each group is independently formed and operated, and therefore data sharing is limited within the group. Further, in general, a maximum number of terminals of one group has a physical upper limit. When the above-described Wi-Fi Direct is built using an inexpensive wireless LAN device, for example, the number of units of the group is limited to an upper limit of approximately 5 to 10 units supported by the device. Such limitation to a group size limits sharing of messages to only terminals in one group and inhibits information sharing in a larger network including a plurality of groups. In the above-described wireless P2P network, it is not possible to report disaster information, traffic information, SOS signals and voice signals with emergency, and the like beyond a local group.

An object of the present invention is to provide a communication method, a communication system, a wireless terminal, communication control method and program therefor that solve the above-described problem, i.e., a problem in which information transmission between groups is difficult in a wireless P2P network.

### Solution to Problem

A communication method according to one example embodiment of the present invention is

a communication method in a wireless communication network including a plurality of nodes each capable of performing wireless communication by a first communication method that can form a Peer-to-Peer group and wireless communication by a second communication method, wherein

a first owner node that operates as an access point of a first Peer-to-Peer group discovers a second Peer-to-Peer group present in a second communicable range that is a region outside a first communicable range defined by the first communication method using the wireless communication by the second communication method, predicts a time that elapses before the second Peer-to-Peer group moves into the first communicable range, and performs group reconfiguration before the predicted time elapses.

A communication system according to another example embodiment of the present invention is

a communication system in a wireless communication network including a plurality of nodes each capable of performing wireless communication by a first communication method that can form a Peer-to-Peer group and wireless communication by a second communication method, the system including:

a first Peer-to-Peer group including a first owner node that operates as an access point and a client node; and

a second Peer-to-Peer group including a second owner node that operates as an access point and a client node, wherein

the first owner node discovers the second Peer-to-Peer group present in a second communicable range that is a region outside a first communicable range defined by the first communication method using the wireless communication by the second communication method, predicts a time that elapses before the second Peer-to-Peer group moves into the first communicable range, and performs group reconfiguration before the predicted time elapses.

A wireless terminal according to another example embodiment of the present invention is

a wireless terminal including:

a first wireless communication unit by a first communication method that can form a Peer-to-Peer group with another wireless terminal;

a second wireless communication unit by a second communication method; and

an automatic connection control unit, wherein
the automatic connection control unit includes a first function of discovering a second Peer-to-Peer group present in a second communicable range that is a region outside a first communicable range defined by the first wireless communication unit using the second wireless communication unit when operating as an access point of a first Peer-to-Peer group, a second function of predicting a time that elapses before the second Peer-to-Peer group moves into the first communicable range, and a third function of performing group reconfiguration before the predicted time elapses.

A communication control method of a wireless terminal according to another example embodiment of the present invention is

a communication control method of a wireless terminal including a first wireless communication unit by a first communication method that can form a Peer-to-Peer group with another wireless terminal and a second wireless communication unit by a second communication method, the communication control method including:

discovering a second Peer-to-Peer group present in a second communicable range that is a region outside a first communicable range defined by the first wireless communication unit using the second wireless communication unit when operating as an access point of a first Peer-to-Peer group;

predicting a time that elapses before the second Peer-to-Peer group moves into the first communicable range; and

performing group reconfiguration before the predicted time elapses.

A program according to another example embodiment of the present invention causes a computer to function as:

a first wireless communication unit by a first communication method that can form a Peer-to-Peer group with another wireless terminal;

a second wireless communication unit by a second communication method; and

an automatic connection control unit including a first function of discovering a second Peer-to-Peer group present in a second communicable range that is a region outside a first communicable range defined by the first wireless communication unit using the second wireless communication unit when operating as an access point of a first Peer-to-Peer group, a second function of predicting a time that elapses before the second Peer-to-Peer group moves into the first communicable range, and a third function of performing group reconfiguration before the predicted time elapses.

### Advantageous Effects of Invention

The present invention includes the above-described configuration, and therefore is capable of transmitting information between a first and a second Peer-to-Peer group via a delivery node.

### BRIEF DESCRIPTION OF DRAWINGS

FIG. 1 is a block diagram of a communication system according to a first example embodiment of the present invention.

FIG. 2 is a flowchart illustrating an operation of the communication system according to the first example embodiment of the present invention.

FIG. 3 is a block diagram of a node (wireless terminal) configuring the communication system according to the first example embodiment of the present invention.

FIG. 4 is a diagram illustrating one example of a connection node list stored by the node configuring the communication system according to the first example embodiment of the present invention.

FIG. 5 is a diagram illustrating one example of group information stored by the node configuring the communication system according to the first example embodiment of the present invention.

FIG. 6 is a diagram illustrating one example of node information stored by the node configuring the communication system according to the first example embodiment of the present invention.

FIG. 7 is a diagram illustrating a connection flow of Wi-Fi Direct used in automatic connection by the communication system according to the first example embodiment of the present invention.

FIG. 8 is a diagram illustrating an operation flow of DEVICE DISCOVERY used in discovery of device by the communication system according to the first example embodiment of the present invention.

FIG. 9 is a diagram illustrating an operation flow of DEVICE DISCOVERY used in discovery of an existing group by the communication system according to the first example embodiment of the present invention.

FIG. 10 is a diagram illustrating an operation flow of GO NEGOTIATION used in automatic connection by the communication system according to the first example embodiment of the present invention.

FIG. 11 is a diagram illustrating an operation flow of PROVISION DISCOVERY used in automatic connection by the communication system according to the first example embodiment of the present invention.

FIG. 12 is a diagram illustrating an operation flow of INVITATION used in automatic connection by the communication system according to the first example embodiment of the present invention.

FIG. 13 is a diagram illustrating an operation flow of node disconnection used in automatic connection by the communication system according to the first example embodiment of the present invention.

FIG. 14 is a diagram illustrating an operation flow of nodes (wireless terminals) configuring the communication system according to the first example embodiment of the present invention.

FIG. 15 is an illustrative diagram of a method in which a GO node of a group of a side of sending a delivery node discovers another group and predicts a shortest time that elapses before the other group moves to a predetermined range in the first example embodiment of the present invention.

FIG. 16 is an illustrative diagram of a method in which a GO node of a group of a side of receiving a delivery node discovers another group and predicts a shortest time that elapses before the other group moves to a predetermined range in the first example embodiment of the present invention.

FIG. 17 is a block diagram of a communication system according to a second example embodiment of the present invention.

FIG. 18 is a flowchart illustrating an operation of the communication system according to the second example embodiment of the present invention.

FIG. 19 is a diagram visually illustrating an influence on information sharing by a delivery node caused by reconfiguration of a group in the second example embodiment of the present invention.

FIG. 20 is a diagram illustrating an operation flow of nodes (wireless terminals) configuring the communication system according to the second example embodiment of the present invention.

FIG. 21 a block diagram of a communication system according to a third example embodiment of the present invention.

FIG. 22 is a flowchart illustrating an operation of the communication system according to the third example embodiment of the present invention.

FIG. 23 is a diagram illustrating an operation flow of nodes (wireless terminals) configuring the communication system according to the third example embodiment of the present invention.

FIG. 24 is an illustrative diagram of an example embodiment that transmits/receives a position-information notification message among nodes via a server.

FIG. 25 is a diagram illustrating an example of predicting the presence or absence of a possibility in which a discovered group moves to a predetermined range and a shortest time that elapses before the movement thereto, using a curvature of a currently-running road.

FIG. 26 is a diagram illustrating an example of predicting the presence or absence of a possibility in which a discovered group moves to a predetermined range and a shortest time that elapses before the movement thereto, using a route estimated from a destination.

### DESCRIPTION OF EMBODIMENTS

Next, example embodiments of the present invention will be described in detail with reference to the accompanying drawings.

### First Example Embodiment

In the present example embodiment, one or a plurality of clients belonging to one group are disconnected as a delivery node and are connected to the other group to transfer information through the delivery node. Further, a range where one group can discover the other group by a Device Discovery procedure of the Wi-Fi Direct specification, i.e., a communicable range is narrow. Therefore, in a situation where groups configured by nodes mounted on moving bodies such as vehicles pass each other at high speed, even if a delivery node is immediately disconnected at the time when one group discovers the other group, the delivery node and the other group are separated far away from each other during the disconnection. Therefore, it is difficult to connect the delivery node to the other group. Further, when the other group that receives the delivery node already reaches an upper limit of the number of members, it is necessary to temporality disconnect an existing node in such a way that the delivery node can be connected. However, when such disconnection is started at the time when the other group enters a communicable range of the Wi-Fi Direct specification, the groups are separated far away from each other during the disconnection. Therefore, it becomes difficult to transfer information through the delivery node. It is also possible for the present example embodiment to solve such a problem.

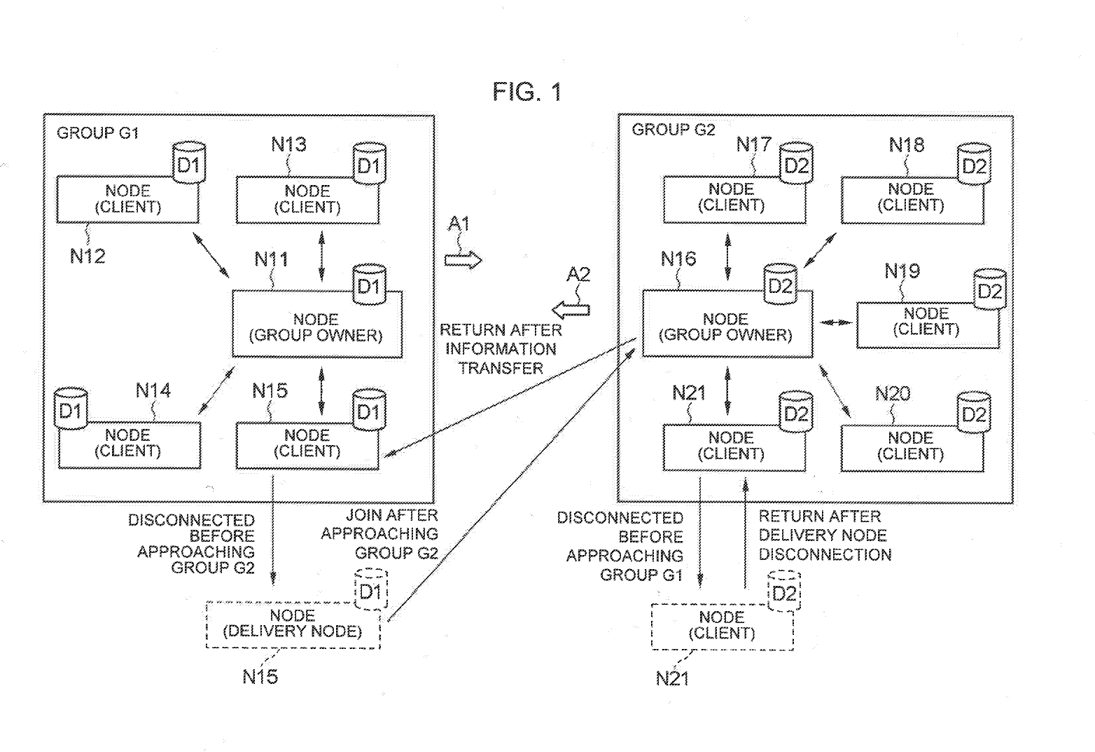

Referring to FIG. 1, a communication system according to a first example embodiment of the present invention is configured by a plurality of nodes N11 to N21. Each of the nodes N11 to N21 is a mobile wireless terminal mounted on a vehicle such as an automobile. Each of the nodes N11 to N21 is capable of performing wireless communication using a first communication method that can form a Peer-to-Peer group and wireless communication using a second communication method different therefrom. The first communication method is Wi-Fi Direct, for example, and the second communication method is cellular communication such as 3G and LTE, for example. Note that the first communication method is not limited to Wi-Fi Direct when being a communication method capable of forming a Peer-to-Peer group with another wireless terminal. Further, the second communication method is not limited to cellular communication when being a wireless communication method capable of performing longer-distance communication than the first communication method.

In FIG. 1, a plurality of nodes N11 to N21 configure two Peer-to-Peer groups G1 and G2 (hereinafter, simply referred to as group(s)) by the first communication method. The group G1 is formed with the node N11 as a parent (group owner), and the nodes N12 to N15 are children (clients) thereof. Further, the group G2 is formed with the node N16 as a group owner, and the nodes N17 to N21 are clients thereof. Still further, data D1 and data D2 are shared in the group G1 and the group G2, respectively. Moreover, the nodes N11 to N15 of the group G1 moving together in a direction indicated by an arrow A1, and the nodes N16 to N21 of the group G2 are moving together in a direction indicated by an arrow A2 opposite to the arrow A1. Such a situation appears when five vehicles mounted with the nodes N11 to N15 of the group G1 are running in a column on a road, and six vehicles mounted with the nodes N16 to N21 of the group G2 are running in a column on a traffic lane opposite to the road, for example.

Here, a maximum number of client nodes connectable to one group owner (hereinafter, referred to as a GO) is assumed to be five for description convenience. Under such limitation, five client nodes N17 to N21 are already connected to the GO node N16 of the group G2, and therefore it is not possible for the GO node N16 to have a new node to be connected thereto any more.

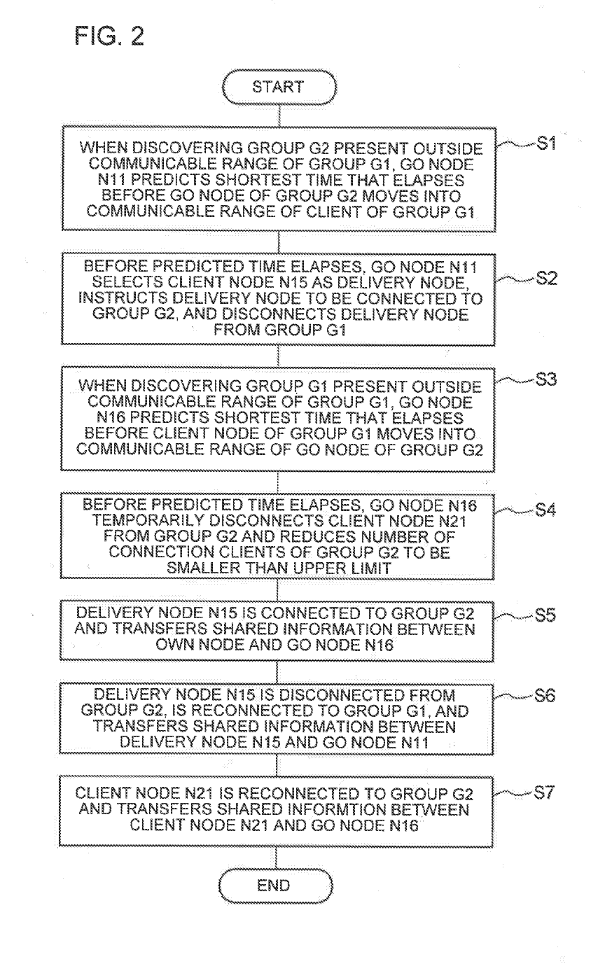

FIG. 2 is a flowchart illustrating an operation of the communication system according to the present example embodiment. With reference to FIG. 2, the following will describe operations for transferring shared information between a group G1 and a group G2 in the communication system according to the present example embodiment. In the present example embodiment, there is described an example in which the group G1 whose number of members does not reach an upper limit operates as a group of a side of sending a delivery node, and the group G2 whose number of members reaches an upper limit operates as a group of a side of receiving a delivery node. However, it is also possible to send a delivery node from both groups.

In a state where groups G1 and G2 are formed, when discovering a second group G2 present outside a communicable range of the group G1 defined by the first communication method, the GO node N11 of the group G1 of a side of sending a delivery node predicts a shortest time necessary for a GO node of the second group G2 to move to a communicable range of a client of the group G1 (step S1).

Subsequently, before the predicted time elapses, the GO node N11 of the group G1 selects the client node N15 of the group G1 as a delivery node, instructs the selected delivery node to be connected to the group G2, and disconnects the delivery node from the group G1 (step S2). Here, one client node is designated as a delivery node, but a plurality of client nodes may be designated as delivery nodes.

On the other hand, when discovering a first group G1 present outside a communicable range of the group G2 defined by the first communication method, the GO node N16 of the group G2 of a side of receiving a delivery node predicts a shortest time necessary for a client node of the first group G1 to move to a communicable range of the GO node of the group G2 (step S3).

Subsequently, before the predicted time elapses, the GO node N16 of the group G2 performs group reconfiguration in preparation for transferring information, through a delivery node, between the group G1 and the group G2. Specifically, before the predicted time elapses, the GO node N16 of the group G2 temporarily disconnects, from the group G2, the client node N21 already connected to the group G2 and thereby reduces the number of connection clients, to allow the delivery node N15 to be newly connectable (step S4). Here, one client node is temporarily disconnected, but a plurality of client nodes may be temporarily disconnected.

In this manner, before the groups G1 and G2 approach each other at a communicable maximum distance or less defined by the first communication method, the group G1 completes disconnection of a delivery node and the group G2 keeps the number of connection members to be smaller than an upper limit.

Next, operations performed when the groups G1 and G2 approach each other at a communicable maximum distance or less defined by the first communication method will be described.

When discovering the GO node N16 of the group G2 by a Device Discovery procedure of the Wi-Fi Direct specification, for example, the delivery node N15 disconnected from the group G1 is connected to the GO node N16, and transfers shared information between the delivery node N15 and the GO node N16 (step S5). Specifically, the delivery node N15 transmits the data D1 to the GO node N16, and the GO node N16 transmits the data D2 to the delivery node N15. Thereby, the GO node N16 of the group G2 can acquire the data D1 shared in the group G1. Moreover, the data D1 is transferred further to the client nodes N17 to N20 from the GO node N16, and thereby the client nodes N17 to N20 can acquire the data D1 shared in the group G1.

Thereafter, the delivery node N15 is disconnected from the group G2 and is reconnected to the GO node N11 of the group G1, and thereby transfers information between the delivery node N15 and the GO node N11 (step S6). Specifically, the delivery node N15 transmits the data D2 to the GO node N11. Thereby, the GO node N11 of the group G1 can acquire the data D2 shared in the group G2. Moreover, the data D2 is transferred further to the client nodes N12 to N14 from the GO node N11, and thereby the client nodes N12 to N14 can acquire the data D2 shared in the group G2.

On the other hand, when the delivery node N15 is disconnected from the group G2, the client node N21 temporarily disconnected from the group G2 is reconnected to the GO node N16 of the group G2 (step S7). Then, the data D1 is transferred to the client node N21 from the GO node N16, and thereby the client node N21 can acquire the data D1 shared in the group G1.

In this manner, shared information can be transmitted between the group G1 and the group G2 via the delivery node N15.

Further, before the groups G1 and G2 approach each other at the communicable maximum distance or less defined by the first communication method, the group G1 completes disconnection of the delivery node N15, and the group G2 completes disconnection of the client node N21 to keep the number of connection members to be smaller than an upper limit. Therefore, in comparison with a case where the delivery node N15 and the client node N21 are disconnected within a time frame when the groups G1 and G2 approach each other at the communicable maximum distance or less defined by the first communication method, a time that can be used for connecting the delivery node N15 to the group G2 increases. Thereby, connection of the delivery node N15 to the group G2 can be prevented from failing due to a lack of time.

The following will describe a configuration and operation of the communication system according to the present example embodiment in more detail.

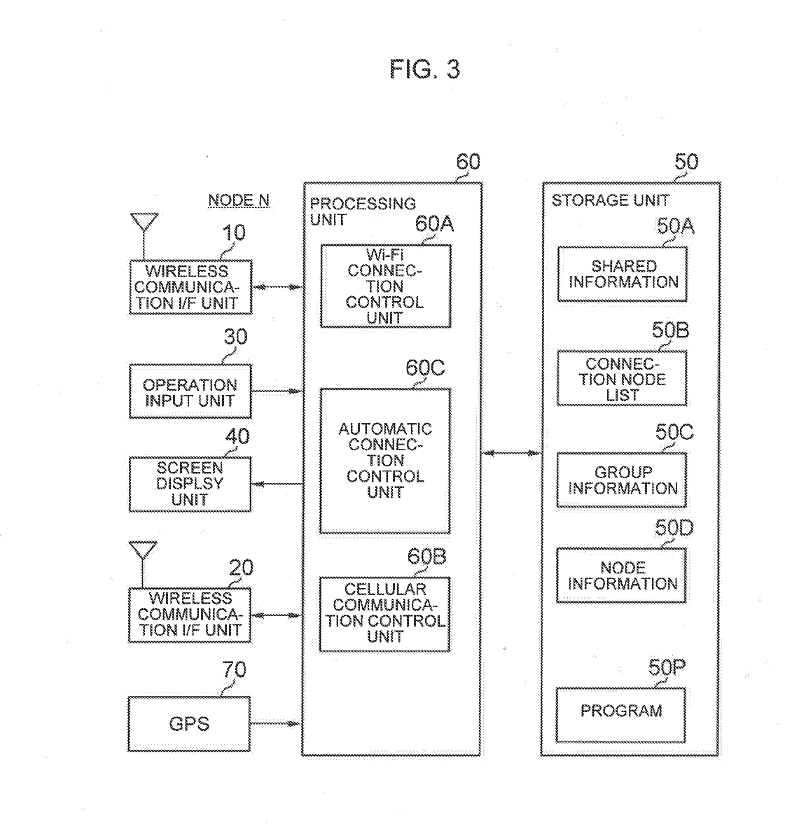

FIG. 3 is a block diagram illustrating a configuration example of a node N used as the nodes N11 to N21. The node N in this example includes wireless communication interface units (hereinafter, referred to as wireless communication I/F units) 10 and 20, an operation input unit 30, a screen display unit 40, a storage unit 50, a processing unit 60, and a GPS (Global Positioning System) 70.

The wireless communication I/F units 10 and 20 each include a dedicated wireless communication circuit, and include a function of performing wireless communication with various types of devices such as other wireless terminals connected via a wireless communication line. Among these, the wireless communication I/F unit 10 is a wireless LAN interface corresponding to Wi-Fi Direct, and the wireless communication I/F unit 20 is a wireless interface corresponding to cellular communication such as 3G and LTE.

The operation input unit 30 includes an operation input device such as a keyboard and a mouse, and includes a function of detecting an operation of an operator and outputting the detected operation to the processing unit 60.

The screen display unit 40 includes a screen display device such as an LCD (Liquid Crystal Display) and a PDP (Plasma Display Panel), and includes a function of screen-displaying various types of information such as an operation menu in accordance with an instruction from the processing unit 60.

The GPS 70 measures a latitude x, a longitude y, and a height z indicating a current position of the node N, and includes a function of transmitting the measured values to the processing unit 60.

The storage unit 50 includes a storage device such as a hard disk and a memory, and includes a function of storing processing information and a program 50P necessary for various types of processing in the processing unit 60. The program 50P is a program for making various types of processing units by being read onto the processing unit 60 to be executed. The program 50P is previously read from an external device (not illustrated) or a storage medium (not illustrated) via a data input/output function such as the communication I/F units 10 and 20, or the operation input unit 30, and is stored on the storage unit 50. Main processing information stored on the storage unit 50 includes shared information 50A, a connection node list 50B, group information 50C, and node information 50D.

The shared information 50A is data mutually shared with another node, and is, for example, disaster information, traffic information, and the like.

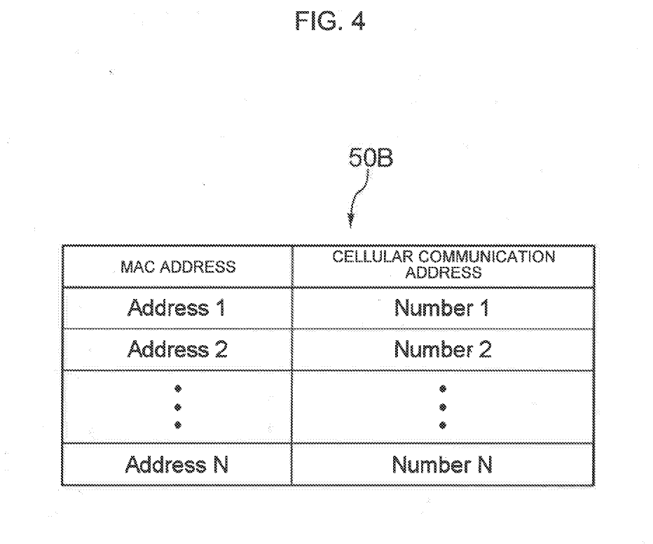

The connection node list 50B is a list of communication addresses of a node permitted for connection. There are two types of communication addresses: one is a communication address of Wi-Fi Direct (e.g., a MAC address); and the other is a communication address of cellular communication (e.g., a phone number or an IP address). FIG. 4 is a configuration example of the connection node list 50B. The connection node list 50B in this example includes a plurality of entries storing a set of an MAC address and a cellular communication address.

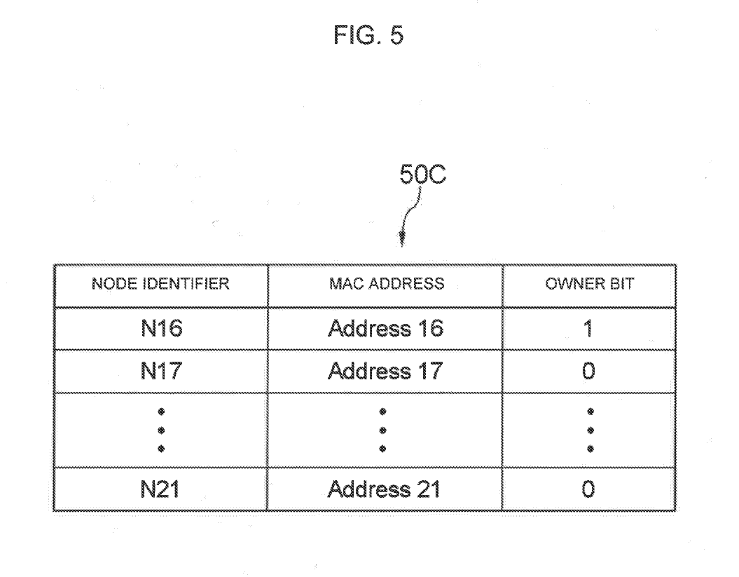

The group information 50C is information relating to a group (P2P group) to which the node N belongs. If the node N has already joined in any group, information for identifying a group owner thereof and information for identifying a client node thereof are registered in the group information 50C. Further, if the node N has not joined in any group, the fact of not joining in any group is registered. The node N manages whether the node N is a group owner or a client by the group information 50C and executes processing in accordance with the group owner or processing in accordance with the client. FIG. 5 is a configuration example of the group information 50C. The group information 50C in this example includes entries storing a set of a node identifier, a MAC address, and an owner bit for a number equal to a number of members of the group. The owner bit is set as value 1 when a node identified by a node identifier or a MAC address of a set thereof is a group owner, and otherwise, i.e., when the node is a client, the owner bit is set as value 0.

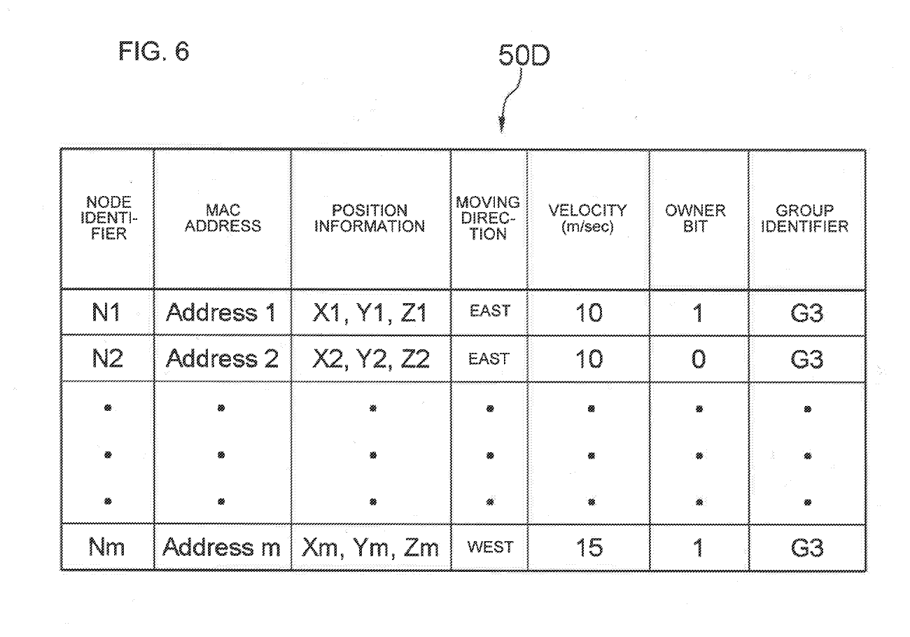

The node information 50D is information in which position information or the like of other nodes is recorded. FIG. 6 is a configuration example of the node information 50D. The node information 50D in this example includes a plurality of entries storing a set of a node identifier, a MAC address, position information, a moving direction, a velocity, an owner bit, and a group identifier. The node identifier is a name or a number for uniquely identifying a node. The MAC address is a communication address for the node. The position information is a latitude x, a longitude y, and a height z indicating a current position of the node. The moving direction and the velocity are a direction and a speed where the node is moving. The owner bit is a bit set as value 1 when a node identified by a node identifier or a MAC address of a set thereof is a group owner, and otherwise, i.e., when the node is a client, the owner bit is a bit set as value 0. With respect to the group identifier, when a node identified by a node identifier or a MAC address of a set thereof is being connected to a P2P group, a name or a number for uniquely identifying the group is recorded, and otherwise, a NULL is recorded, for example.

The processing unit 60 includes a microprocessor such as a MPU and a peripheral circuit thereof, and includes a function of reading the program 50P from the storage unit 50 to execute the read program, and thereby making various types of processing units by the cooperation of the above hardware and program 50P. Main processing units made by the processing unit 60 include a Wi-Fi connection control unit 60A, a cellular communication control unit 60B, and an automatic connection control unit 60C.

The Wi-Fi connection control unit 60A is a block that generates a packet of Wi-Fi Direct, transmits the generated packet through the wireless communication I/F unit 10, and receives a packet of Wi-Fi Direct also through the wireless communication I/F unit 10. The Wi-Fi connection control unit 60A performs control in units such as “Device Discovery”, “Group Formation”, “WPS (Wi-Fi Protected Setup) Provisioning Phase 1”, and “WPS Provisioning Phase 2”. Further, the Wi-Fi connection control unit 60A receives an event (command) from the automatic connection control unit 60C to start control, and reports the result to the automatic connection control unit 60C as an event (response).

The cellular communication control unit 60B is a block that generates a packet of cellular communication, transmits the generated packet through the wireless communication I/F unit 20, and receives a packet of cellular communication through the wireless communication I/F unit 20. When receiving an event (command) from the automatic connection control unit 60C, the cellular communication control unit 60B performs control in accordance with the event and reports the result to the automatic connection control unit 60C as an event (response).

The automatic connection control unit 60C is a control unit located in an upper layer of the Wi-Fi connection control unit 60A and the cellular communication control unit 60B. The automatic connection control unit 60C controls the cellular communication control unit 60B, and thereby performs transmission/reception of a message across P2P groups of Wi-Fi Direct. Further, the automatic connection control unit 60C controls the Wi-Fi connection control unit 60A, and thereby performs automatic connection by Wi-Fi Direct. Specifically, when nodes come close to each other, for example, one group is automatically constructed and inter-node communication is carried out in the group. Further, when a new node comes close to an already-constructed group, the node automatically joins the already-constructed group. Still further, a node is automatically disconnected from the already-constructed group. The automatic connection control unit 60C performs the information sharing method described with reference to FIG. 2 in a Wi-Fi P2P network by such processing for connection and disconnection of Wi-Fi Direct.

Hereinafter, functions of the automatic connection control unit 60C will be described in more detail. First, a function of connection and disconnection of Wi-Fi Direct will be described. Then, a control function relating to the information sharing described with reference to FIG. 2 will be described.

### <Connection and Disconnection of Wi-Fi Direct>

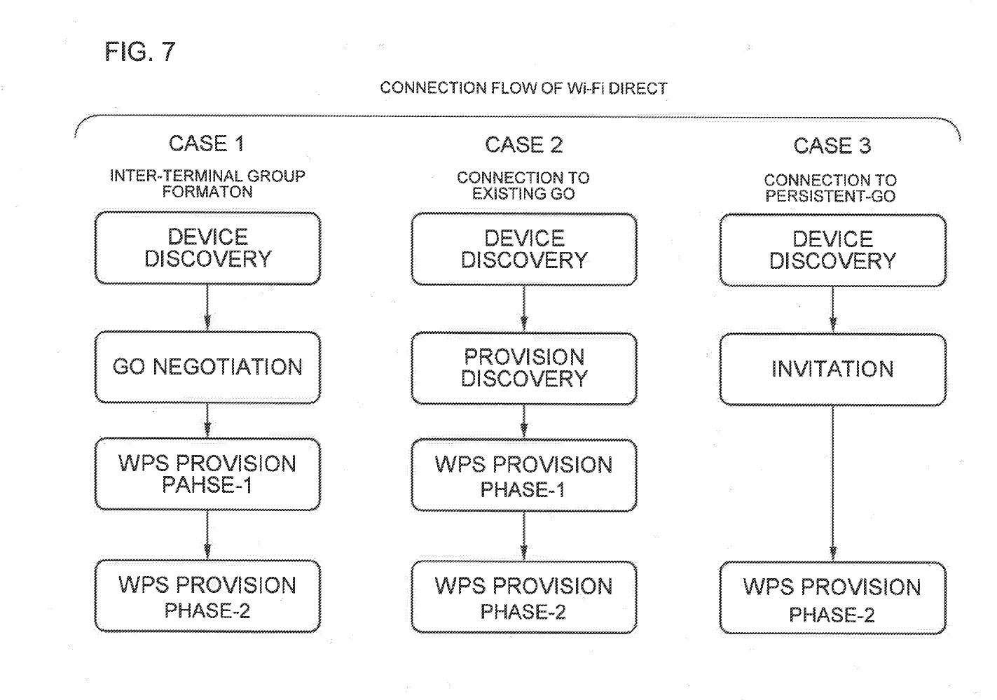

As illustrated in FIG. 7, when a group is formed between nodes (CASE 1), first, neighboring P2P nodes are searched by Device Discovery processing. When the P2P nodes are discovered, any one of the nodes becomes a group owner (GO) by GO Negotiation processing and the other node becomes a client to be connected. Next, WPS Provision Phase-1 (authentication phase) and Phase-2 (encryption phase) are sequentially executed.

In a case where connection is made to an existing GO (CASE 2), first, a neighboring P2P node is searched by Device Discovery processing. When the discovered P2P node is a GO, connection to the GO is made by Provisional Discovery processing. Next, WPS Provision Phase-1 (authentication phase) and Phase-2 (encryption phase) are sequentially executed.

In a case where connection is made to a Persistent GO (CASE 3), first, a neighboring P2P node is searched by Device Discovery processing. When the discovered P2P node is a Persistent GO, connection is made to the Persistent GO by Invitation processing. Next, WPS Provision Phase-2 (encryption phase) is sequentially executed.

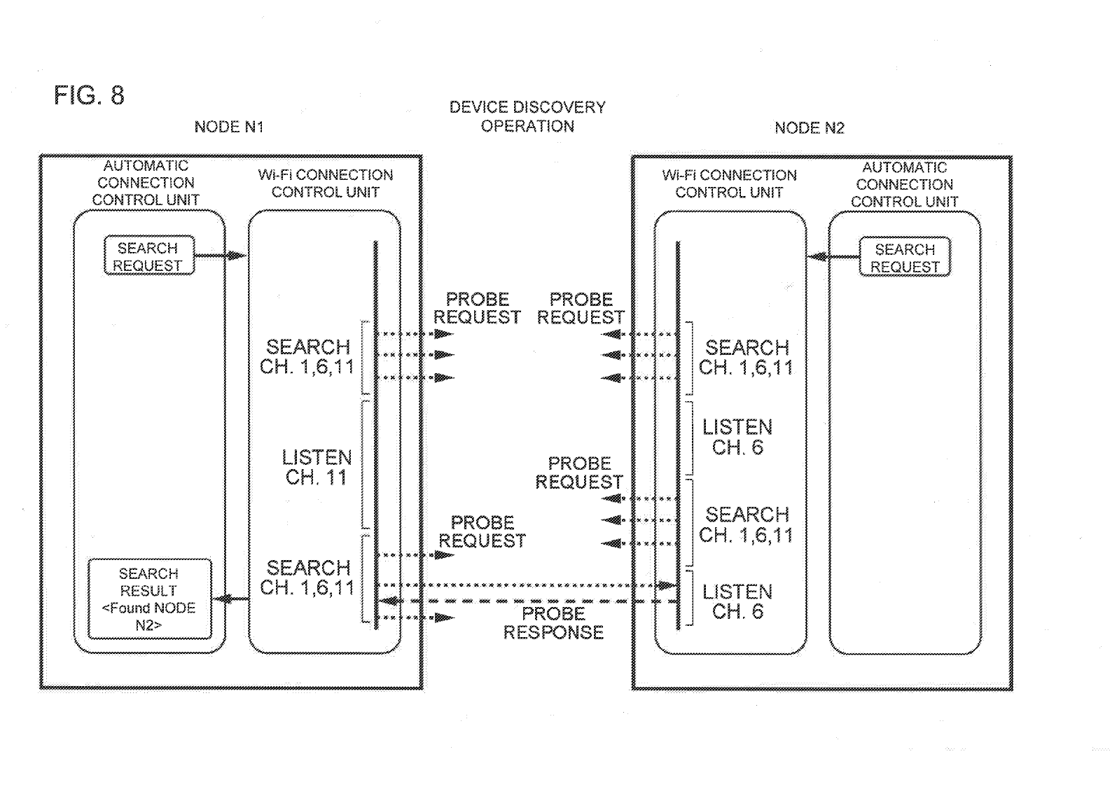

As exemplarily illustrated in FIG. 8, a Device Discovery operation is executed. In other words, when receiving a search request from an automatic connection control unit, a Wi-Fi connection control unit in each node starts searching an adjacent node and alternately repeats a Search state and a Listen state. In the Search state, the Wi-Fi connection control unit transmits a Probe Request while sequentially switching a predetermined channel, and waits for a Probe response that is a response to the request. In the Listen state, the Wi-Fi connection control unit waits for a Probe Request from another node, and when receiving a Prove Request, returns a Probe Response for the received request. When the node N1 is a client of a group, upon receipt of a Probe Response from the node N2, the Wi-Fi connection control unit of the node N1 reports information of the adjacent node N2 to a group owner of the group of node N1 as adjacent node information.

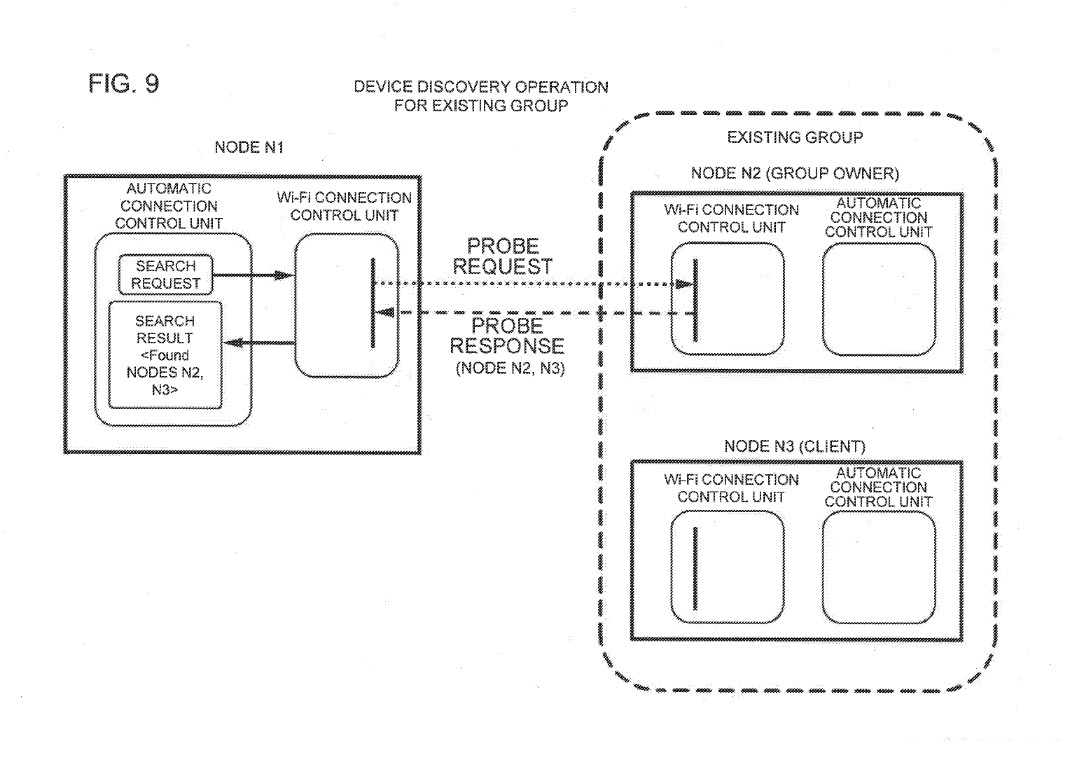

As exemplarily illustrated in FIG. 9, a Device Discovery operation for an existing GO is executed. When a group with the node N2 being a group owner is already constructed, the GO node N2 returns a Probe Response for a Probe Request from the node N1. At that time, a P2P Device Info Attribute of the Probe Response from the GO node N2 includes a list of clients belonging to the group (here, information of the nodes N2 and N3).

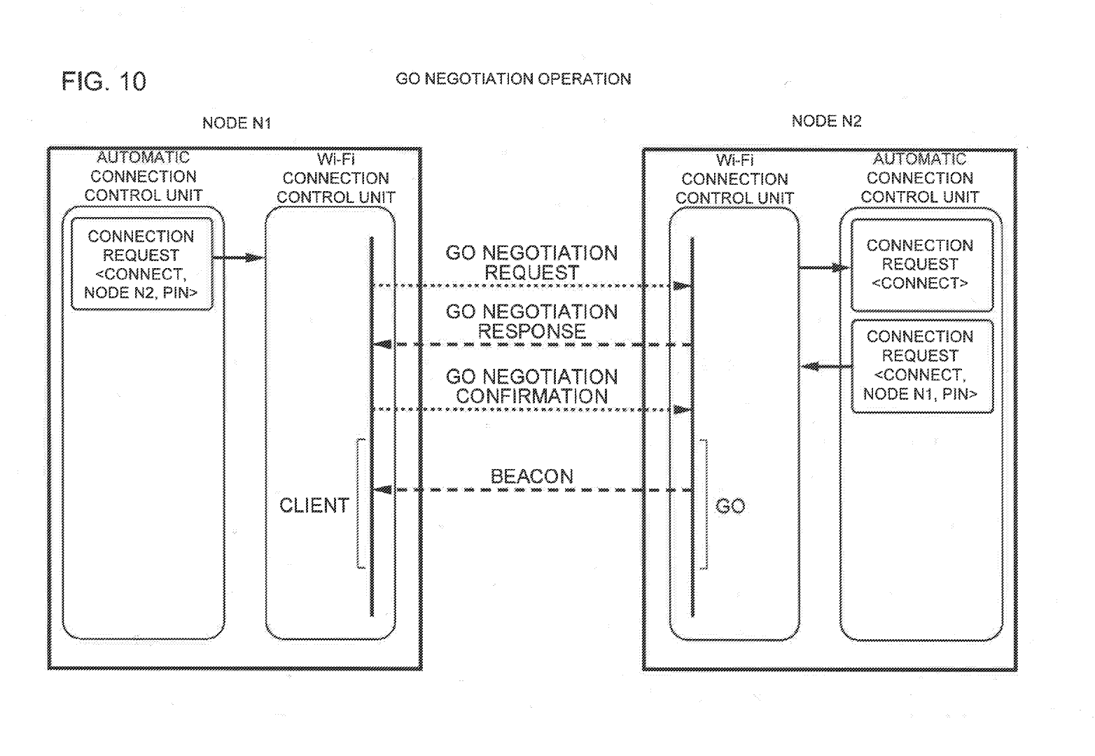

As exemplarily illustrated in FIG. 10, a GO Negotiation operation upon forming a group between terminals is executed. A GO Negotiation Request, a GO negotiation Response, and a GO Negotiation Confirmation are exchanged between nodes, and thereby one node becomes a GO to start broadcasting a beacon.

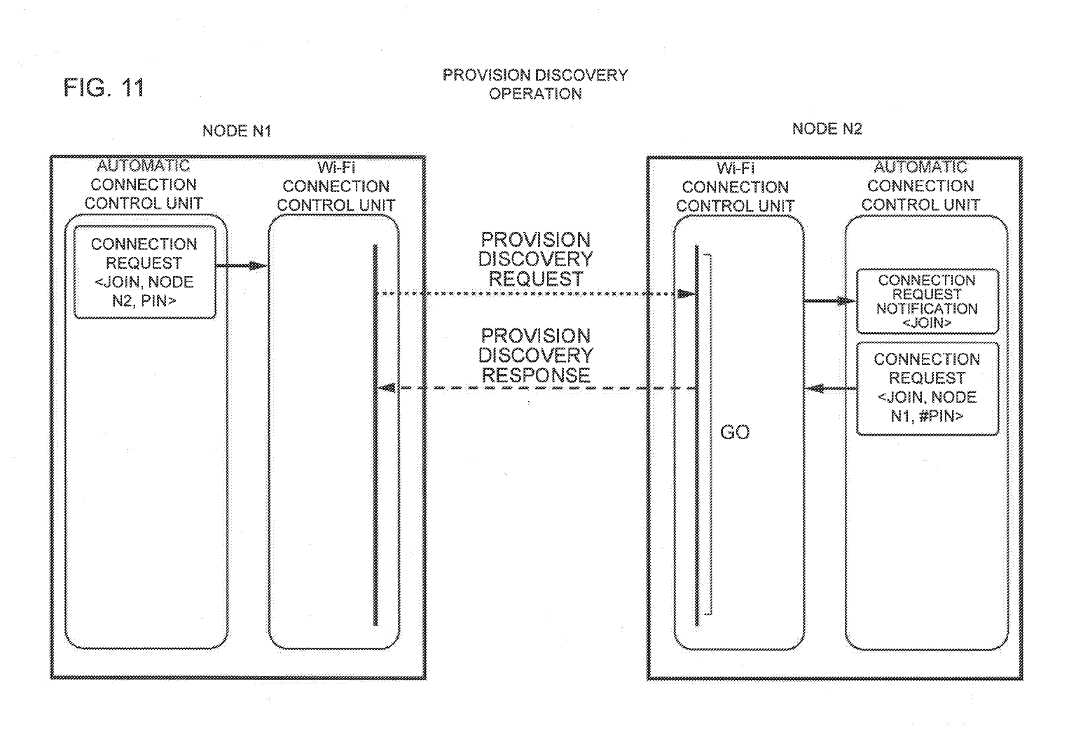

As exemplarily illustrated in FIG. 11, a Provision Discovery operation for connection to an existing GO is executed. For a Provision Discovery Request from the node N1 to the node N2, the GO node N2 returns a Provision Discovery Response to the node N1, and thereby the node N1 is connected to the node N2.

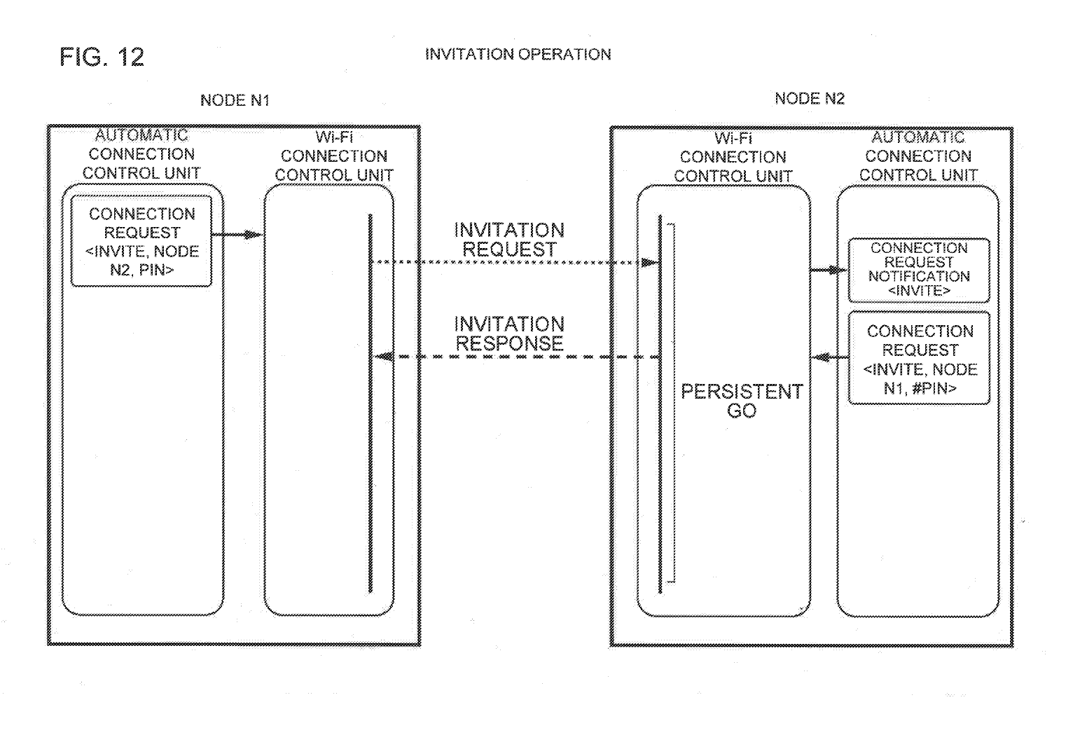

As exemplarily illustrated in FIG. 12, an Invitation operation for connection to a Persistent-GO is executed. For an Invitation Request from the node N1 to the node N2, the Persistent-GO node N2 returns an Invitation Response to the node N1, and thereby the node N1 is connected to the node N2.

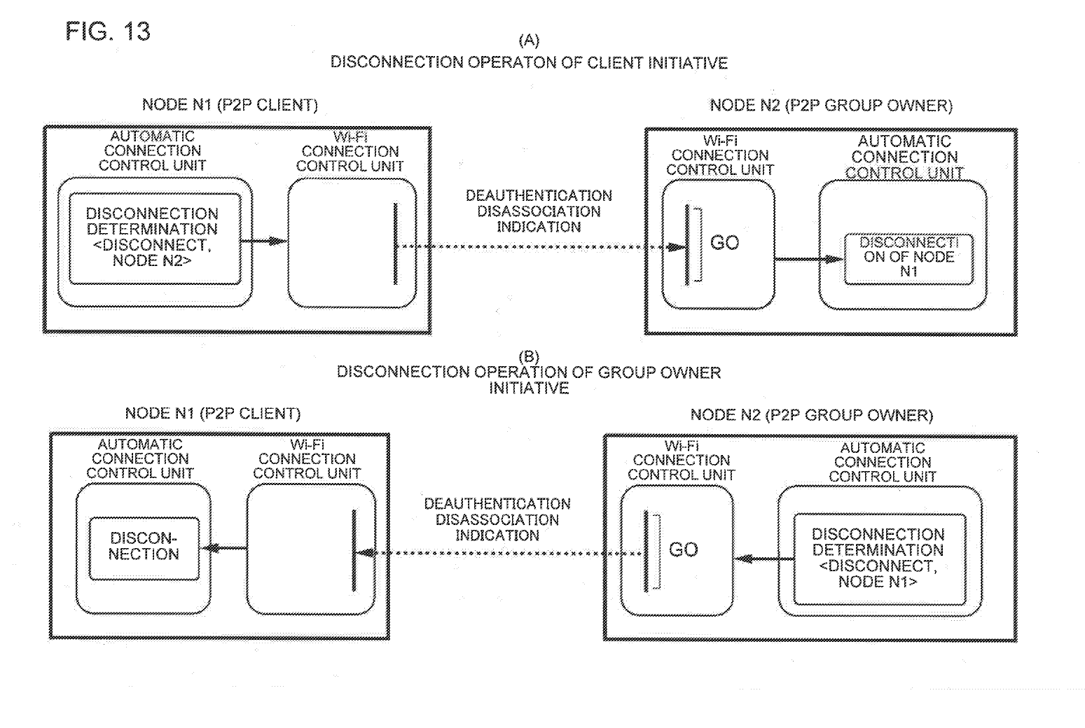

As illustrated in FIG. 13, in a client-initiative disconnection, the client node N1 transmits a Deauthentication or Disassociation Indication to the GO node N2 to enable disconnection. Inversely, in a group-owner-initiative disconnection, the GO node N2 transmits a Deauthentication or Disassociation Indication to the client node N1, to enable the client to be disconnected.

### <Control Function Relating to Information Sharing>

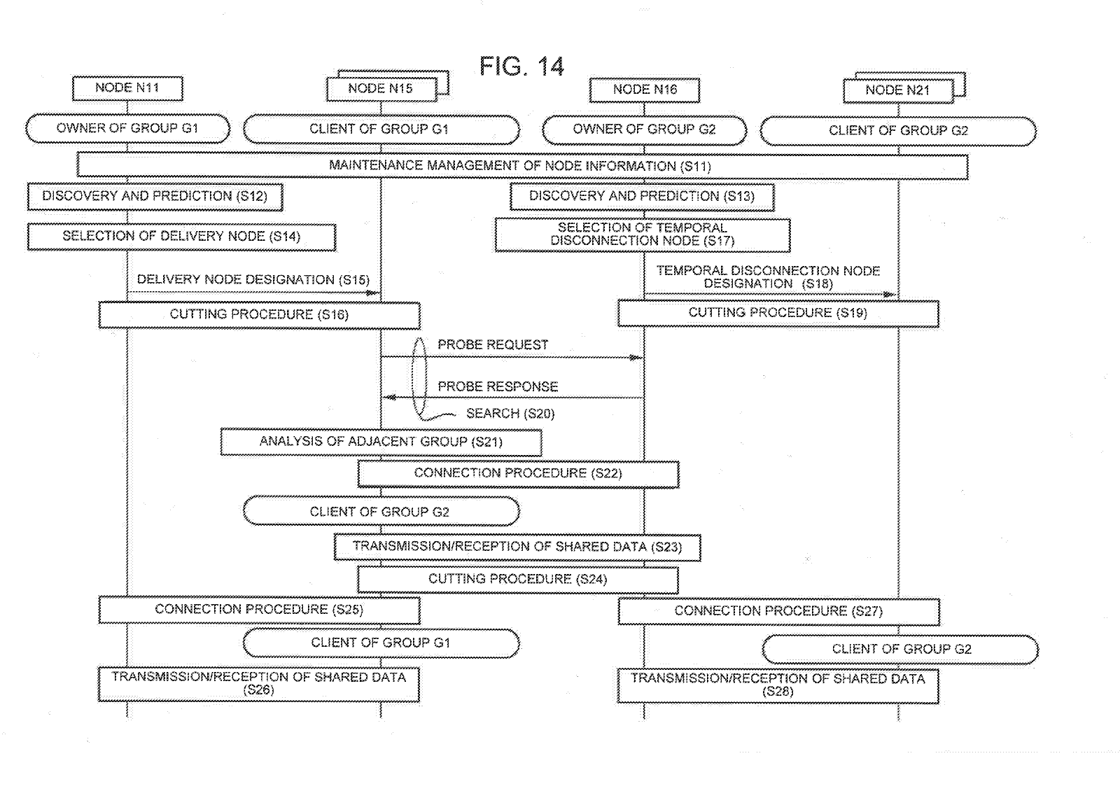

FIG. 14 is a flowchart illustrating an operation of the node N according to the present example embodiment. Hereinafter, with reference to FIG. 14, an operation of the node N upon sharing information between the group G1 and the group G2 will be described.

In a state where groups G1 and G2 are formed as illustrated in FIG. 1, the automatic connection control units of the nodes N11 to N21 of the groups G1 and G2 transmit/receive a position-information notification message to/from another node at a constant cycle by cellular communication. Thereby, the automatic connection control units maintain contents of the node information 50D illustrated in FIG. 6 in the latest state (S11). In the position information notification message transmitted from the node N, a current position of the node N detected in the GPS 70, a moving direction, a velocity, a node identifier of the node N, a MAC address, an owner bit, and a group identifier are stored. The moving direction is obtained by detecting a direction of a current position of the node N this time viewed from a current position last time, for example. Further, the velocity is obtained by dividing a difference between the current position last time and the current position this time of the node N by a difference between detection clock times thereof, for example. A transmission destination includes all the nodes where cellular communication addresses are recorded on the connection node list 50B. However, for another node connected to the same group as the node N managed by the group information 50D, transmission may be performed by Wi-Fi Direct communication instead of cellular communication. Further, when receiving a position-information notification message from another node, the automatic connection control unit 60D records the received message in the node information 50D of the storage unit 50. Specifically, when an entry including a node identifier or a MAC address matched with a node identifier or a MAC address in the received position information notification message does not exist in the node information 50D, the automatic connection control unit 60D stores the received position information notification message in a new entry and adds the new entry to the node information 50D. When such entry exists, the automatic connection control unit 60D overwrites the existing entry by the received position-information notification message.

The automatic connection control unit of the GO node N11 of the group G1 of a side of sending a delivery node discovers a group that is approaching the group G1 based on the latest node information 50D. Further, the automatic connection control unit predicts a shortest time that elapses before the discovered group moves to a predetermined range (S12). In the same manner, the automatic connection control unit of the GO node N16 of the group G2 of a side of receiving a delivery node discovers a group that is approaching the group G2 based on the latest node information 50D. Further, the automatic connection control unit predicts a shortest time that elapses before the discovered group moves to a predetermined range (S13). Hereinafter, details of a method in which the GO node N11 discovers another group and predicts a shortest time that elapses before the other group moves to a predetermined range will be described.

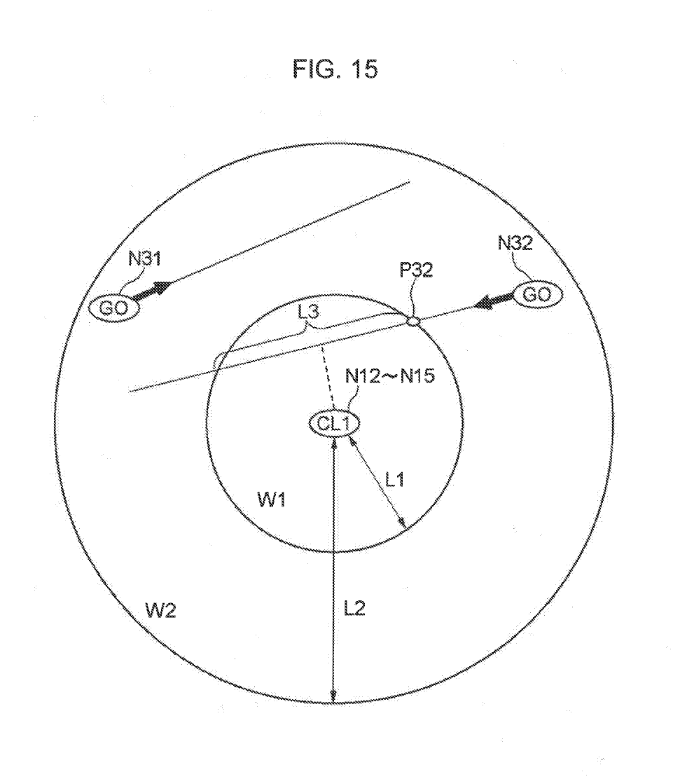

The automatic connection control unit of the GO node N11 sets, as a search region, a donut-shaped region W2 illustrated in FIG. 15 for each of the client nodes N12 to N15 of the group G1. Then, the automatic connection control unit detects a GO node of another group existing in the search region W2. The search region W2 is a region excluding a range W1 of a circle having a radius of a communicable maximum distance L1 based on Wi-Fi Direct from a circle having a radius L2 with a client node as a center. The automatic connection control unit uses, as the distance L1, a maximum value or an average value of distances between another node discovered by a Device Discovery procedure of the Wi-Fi Direct specification executed in the past and the GO node N11, for example. The distance L2 is not limited when being longer than the distance L1, but when being excessively long, the automatic connection control unit needlessly detects another group that is less likely to move into the region W1. Therefore, it is preferable to set the distance L2 an appropriate length. Note that the shape of the search region W2 is not limited to a donut shape as illustrated in FIG. 15, and may be another shape such as a rectangle.

The automatic connection control unit of the GO node N11 detects, from the node information 50D illustrated in FIG. 6, a GO node in which the position information indicates a position within the search region W2 of any one of the client nodes N12 to N15 (however, the GO node N11 itself is excluded). In other words, the automatic connection control unit detects an entry in which XY coordinate values indicated by position information xi and yi are included in the search region W2 and the owner bit is 1, from the node information 50D. Hereinafter, the detected GO node will be written as another GO node. Next, the automatic connection control unit predicts a shortest time that elapses before another GO node moves to the region W1 for each region W1 of the client nodes N12 to N15 of the group G1. This is described below using the GO node N21 and the client node N12 as an example.

The automatic connection control unit of the GO node N11 first calculates, from moving directions and velocities of the client node N12 and another GO node N21, a relative velocity between the client node N12 and the another GO node N21. Next, the automatic connection control unit researches whether an extended line extending in a vector direction of the relative velocity crosses the region W1 of the client node by designating a current position of the another GO node N21 as a start point. The automatic connection control unit determines that there is a possibility in which the another GO node N21 moves to the region W1 of the client node N12 when the extended line crosses the region W1. The automatic connection control unit determines that there is no possibility of the above description when the extended line does not cross the region W1. When determining that there is a possibility, the automatic connection control unit divides a distance from an intersection between the extended line and an outer edge of the region W1 of the client node N12 to the current position of the another GO node N21 by the relative velocity. The automatic connection control unit thereby calculates a shortest time that elapses before the another GO node N21 moves to the region W1. For example, upon regarding W1 of FIG. 15 as the region W1 of the client node N12, when a GO node N31 drawn in FIG. 15 is another GO node N21, an extended line extending from a current position thereof in a vector direction of a relative velocity does not cross the region W1. Therefore, it is determined that there is no possibility of moving to the region W1. On the other hand, when a GO node N32 drawn in FIG. 15 is another GO node N21, an extended line extending from a current position thereof in a vector direction of a relative velocity crosses the region W1. Therefore, it is determined that there is a possibility of moving to the region W1. Further, the automatic connection control unit divides a distance from an intersection P32 between the extended line and an outer edge of the region W1 to the GO node N32 by the relative velocity, and calculates a time that elapses before the GO node N32 moves to the region W1. The automatic connection control unit of the GO node N11 executes the same calculation with respect to another GO node N21 for the remaining client nodes N13 to N15. Further, the automatic connection control unit sets a minimum time or an average time of times calculated for the client nodes N12 to N15 as a shortest time that elapses before the group G2 to which another GO node N21 belongs moves to a communicable range of a client node of the group G1.

Next, a method for discovering another group by the GO node N16 of the group G2 of a side of receiving a delivery node and predicting a shortest time that elapses before the other group moves to a predetermined range will be described in detail.

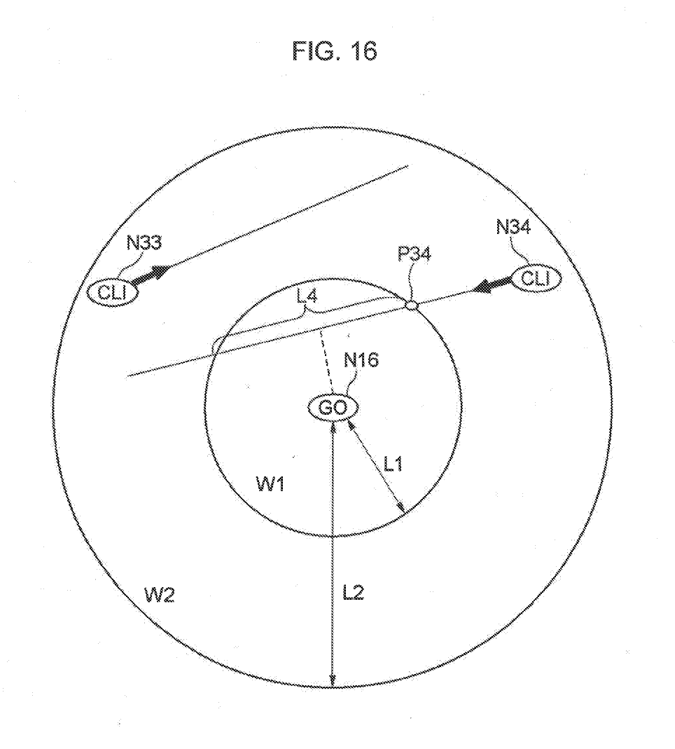

The automatic connection control unit of the GO node N16 of the group G2 sets, as a search region, a donut-shaped region W2 illustrated in FIG. 16 in the GO node N16 itself and detects a client node of another group existing in the search region W2. The search region W2 is a region excluding a range W1 of a circle having a radius of a communicable maximum distance L1 based on Wi-Fi Direct from a circle having a radius L2 with the GO node N16 as a center. The automatic connection control unit uses, as the distance L1, a maximum value or an average value of distances between another node discovered by a Device Discovery procedure of the Wi-Fi Direct specification executed in the past and the GO node N16, for example. The distance L2 is not limited when being longer than the distance L1, but when being excessively long, the automatic connection control unit needlessly detects another node that is less likely to move to the region W1. Therefore, it is preferable to set an appropriate length. Note that the shape of the search region W2 is not limited to a donut shape as illustrated in FIG. 16, and may be another shape such as a rectangle.

The automatic connection control unit of the GO node N16 detects, from the node information 50D illustrated in FIG. 6, a client node in which the position information indicates a position within the search region W2 of the GO node N16 (however, a client of the group G2 is excluded). In other words, the automatic connection control unit detects an entry in which XY coordinate values indicated by position information xi and yi are included in the search region W2 and an owner bit is 0, from the node information 50D. Hereinafter, the detected client node will be written as another client node. Next, the automatic connection control unit predicts a shortest time that elapses before another client node moves to the region W1 of the GO node N16 of the group G2, as described below. This is described below using the GO node N16 and the client node N15 as an example.

The automatic connection control unit of the GO node N16 first calculates a relative velocity between the GO node N16 and the another client node N15 from moving directions and velocities of the GO node N16 and another client node N15. Next, the automatic connection control unit researches whether an extended line extending in a vector direction of the relative velocity crosses the region W1 of the GO node N16 by designating a current position of the another client node N15 as a start point. Further, the automatic connection control unit determines that there is a possibility in which the another client node N15 moves to the region W1 of the GO node N16 when the extended line crosses the region W1. The automatic connection control unit determines that there is no possibility of the above description when the extended line does not cross the region W1. When determining that there is a possibility, the automatic connection control unit divides a distance from an intersection between the extended line and an outer edge of the region W1 of the GO node N16 to the current position of the another client node N15 by the relative velocity. The automatic connection control unit thereby calculates a shortest time that elapses before the another client node N15 moves to the region W1. When a client node N33 drawn in FIG. 16 is regarded as a client node N16, for example, an extended line extending from a current position thereof in a vector direction of a relative velocity does not cross the region W1. Therefore, it is determined that there is no possibility of moving to the region W1. On the other hand, when a client node N34 drawn in FIG. 16 is regarded as a client node N16, an extended line extending from a current position thereof in a vector direction of a relative velocity crosses the region W1. Therefore, it is determined that there is a possibility of moving to the region W1. Further, the automatic connection control unit divides a distance from an intersection P34 between the extended line and an outer edge of the region W1 to the client node N34 by the relative velocity. The automatic connection control unit thereby calculates a time that elapses before the client node N34 moves to the region W1. The automatic connection control unit of the GO node N11 executes the same calculation for the remaining client nodes N12 to N14 of the group G1. Further, the automatic connection control unit sets a minimum time or an average time of times calculated for all the client nodes of the group G1 as a shortest time that elapses before the group G1 moves to a communicable range of the group G2.

Referring again to FIG. 14, the automatic connection control unit of the GO node N15 of the group G1 discovers the group G2 in step S12 and calculates a shortest time necessary for a GO node of the group G2 to move to a communicable range of a client of the group G1. The automatic connection control unit then executes delivery node selection (S14), delivery node designation (S15), and delivery node cutting (S16) before the shortest time elapses.

In the delivery node selection (S14), the automatic connection control unit of the GO node N15 of the group G1 selects, as a delivery node, a client node having a possibility of coming closest to or a possibility of approaching the GO node N16 of the group G2 at a predetermined distance threshold or less. Specifically, in FIG. 15, when the GO node N32 is regarded as the GO node N16, among the client nodes N12 to N15, a client node having a shortest length or a client node having a threshold or less of a perpendicular line (illustrated by a dashed line) drawn downward to an extended line of the GO node N32 from the center of the region W1 is selected as a delivery node. Alternatively, in the delivery node selection, a client node having a possibility of being connectable over a longest time or a client node having a possibility of being connectable over a time of a predetermined time threshold or more with respect to the GO node N16 of the group G2 may be selected as a delivery node. Specifically, in FIG. 15, when the GO node N32 is regarded as the GO node N16, among the client nodes N12 to N15, a client node in which a time obtained by dividing a length L where an extended line of the GO node 32 crosses the region W1 by a relative velocity of the client node and the GO node N32 is longest or a client node in which the time is equal to or larger than a threshold is selected as a delivery node.

Further, in the delivery node designation (S15), the automatic connection control unit of the group G1 designates information (e.g., a MAC address) of the node N16 to be connected after disconnection from the group G1, a condition for reconnection to the group G1, and the like. As the condition for reconnection, reconnecting to the GO node N11 after transmission/reception of shared data to/from the node N16, and reconnecting to the GO node N11 when a certain time elapses after disconnection from the group G1 are conceivable.

Further, in the delivery node cutting (S16), the automatic connection control unit of the group G1 executes a cutting procedure between the automatic connection control unit of the group G1 and the automatic connection control unit of the client node N15.

On the other hand, the automatic connection control unit of the group G2 discovers the group G1 in step S13 and calculates a shortest time necessary for a client of the group G1 to move to a communicable range of a GO node of the group G2. The automatic connection control unit then executes temporal disconnection node selection (S17), temporal disconnection node designation (S18), and temporal disconnection node cutting (S19) before the shortest time elapses.

In the temporal disconnection node selection (S17), the automatic connection control unit of the group G2 selects one or a plurality of client nodes connected to the group G2 as temporal disconnection nodes. In the example of FIG. 1, the client node N21 is selected as a temporal disconnection node.

Further, in the temporal disconnection node designation (S18), the automatic connection control unit of the group G2 designates information (e.g., a MAC address) of the node N16 to be reconnected after disconnection from the group G2 and a condition for reconnection to the group G2. As the condition for reconnection, reconnecting to the GO node N16 when a certain time elapses after disconnection from the group G2 is conceivable. In addition, reconnecting to the GO node N16 at the time when the number of terminals of the group G2 increases once, for example, to an upper limit of a connection client number and then decreases again after disconnection from group G2 is also conceivable.

Further, in the temporal disconnection node cutting (S19), the automatic connection control unit of the group G2 executes a cutting procedure between the automatic connection control unit of the group G2 and an automatic connection control unit of a node selected as a temporal disconnection node.

The automatic connection control unit of the delivery node N15 disconnected from the group G1 searches a neighboring group. This search is performed in conformity to a Device Discovery procedure of the Wi-Fi Direct specification. In FIG. 14, for example, the delivery node N15 sends a probe request for Device Discovery processing, receives a probe response from an adjacent group G2 (S20), and thereby discovers the GO node N16 of the group G2. When discovering the GO node N16 of the group G2, the automatic connection control unit of the delivery node N15 analyzes the adjacent group (S21). In this analysis, it is determined whether the adjacent group is a connection destination requested by the delivery node designation. This determination is performed by researching whether a MAC address that is information for identifying the GO node N16 included in a probe request or a probe response transmitted from the GO node N16 of the group G2 is matched with a MAC address of a connection destination designated by the delivery node designation, for example. When the MAC addresses are matched, it is determined that the group is connectable. When the MAC addresses are not matched, it is determined that the group is unconnectable and the automatic connection control unit continues to search another group.

When discovering the GO node N16 of the group G2 having the MAC address designated in the delivery node designation, the automatic connection control unit of the delivery node N15 executes a connection procedure between the automatic connection control unit of the delivery node N15 and the automatic connection control unit of the GO node N16 (S22). Thereby, the delivery node N15 becomes a client node of the group G2.

The delivery node N15 having become a client node of the group G2 transfers shared information between the delivery node and the GO node N16 (S23). Specifically, the automatic connection control unit of the delivery node N15 transmits the shared information 50A (data D1) on the storage unit to the GO node N16 using the Wi-Fi connection control unit 60A. Further, the automatic connection control unit of the GO node N16 receives the shared information 50A (data D1) from the delivery node N15 using the Wi-Fi connection control unit 60A and stores the received information on the storage unit 50. Inversely, the automatic connection control unit of the GO node N16 transmits the shared information 50A (data D2) on the storage unit to the delivery node N15 using the Wi-Fi connection control unit 60A. Further, the automatic connection control unit of the delivery node N15 receives the shared information 50A (data D2) from the GO node N16 using the Wi-Fi connection control unit 60A and stores the received information on the storage unit 50. Thereafter, although not illustrated in FIG. 14, the data D1 is transferred from the GO node N16 to the client nodes N17 to N20 being connected.

Then, the delivery node N15 is first disconnected from the group G2 when a reconnection condition for the group G1 is satisfied (S24). At that time, a cutting procedure is executed under control of the automatic connection control unit of the GO node N16 and the automatic connection control unit of the delivery node N15. The delivery node N15 is then reconnected to the GO node N11 of the group G1 (S25). At that time, a connection procedure is executed under control of the automatic connection control unit of the GO node N11 and the automatic connection control unit of the delivery node N15.

The delivery node N15 again having become a client of the group G1 transfers shared information between the client node N15 and the GO node N16 (S26). Specifically, the automatic connection control unit of the delivery node N15 transmits the shared information 50A (data D2) on the storage unit to the GO node N11 using the Wi-Fi connection control unit 60A. Further, the automatic connection control unit of the GO node N11 receives the shared information 50A (data D2) from the delivery node N15 using the Wi-Fi connection control unit 60A and stores the received information on the storage unit 50. Thereafter, although not illustrated in FIG. 14, the data D2 is transferred from the GO node N11 to the client nodes N11 to N14 being connected.

On the other hand, the temporal disconnection node N21 is reconnected to the GO node N16 of the group G2 when a reconnection condition for the group G2 is satisfied (S27). At that time, a connection procedure is executed under control of the automatic connection control unit of the GO node N16 and the automatic connection control unit of the temporal disconnection node N21. The node N21 again having become a client of the group G2 transfers shared information between the client node N21 and the GO node N16 (S28). Specifically, the automatic connection control unit of the GO node N16 transmits the shared information 50A (data D1) on the storage unit to the node N16 using the Wi-Fi connection control unit 60A. Further, the automatic connection control unit of the node N21 receives the shared information 50A (data D1) from the GO node N16 using the Wi-Fi connection control unit 60A, and stores the received information on the storage unit 50.

In this manner, the present example embodiment transmits shared information between groups.

### Second Example Embodiment

In the present example embodiment, group reconfiguration is performed by allowing a GO node belonging to one group to be a client node, and the node having become the client node is disconnected as a delivery node to be connected to the other group, whereby information is transferred via the delivery node.

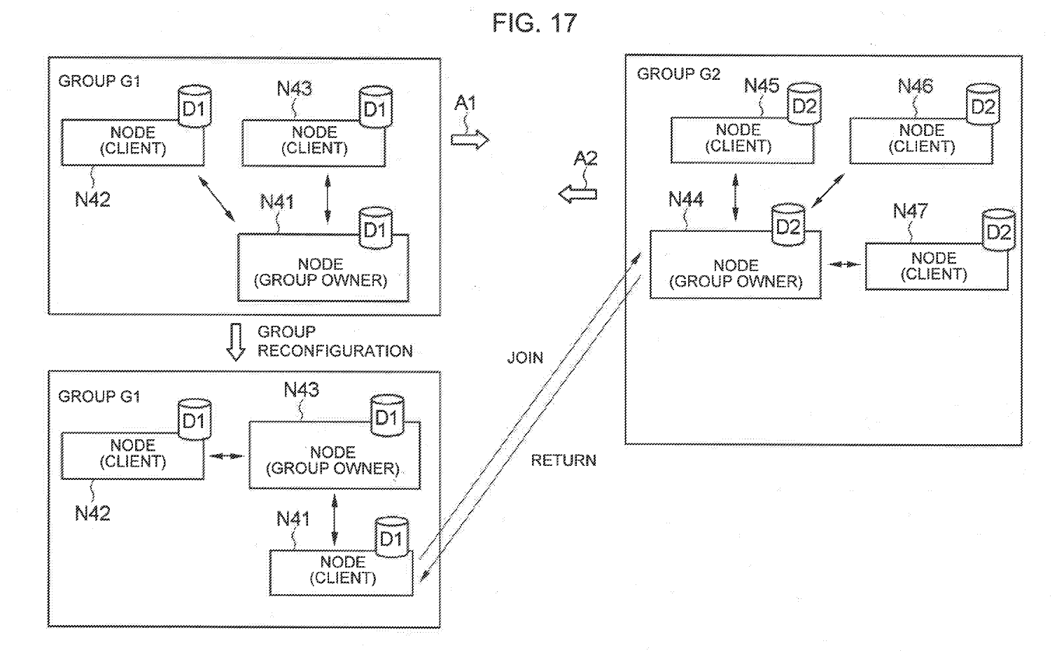

Referring to FIG. 17, a communication system according to a second example embodiment of the present invention includes a plurality of nodes N41 to N47. Each of the nodes N41 to N47 is a mobile wireless terminal mounted on a vehicle such as an automobile. Each of the nodes N41 to N47 is capable of performing wireless communication using a first communication method that can form a Peer-to Peer group and wireless communication using a second communication method different therefrom. The first communication method is Wi-Fi Direct, for example, and the second communication method is cellular communication such as 3G and LTE. Note that the first communication method is not limited to Wi-Fi Direct when being a communication method capable of forming a Peer-to-Peer group with another wireless terminal. Further, the second communication method is not limited to cellular communication when being a wireless communication method capable of performing longer-distance communication than the first communication method.

In FIG. 17, a plurality of nodes N41 to N47 configure two Peer-to-Peer groups G1 and G2 (hereinafter, simply referred to as groups) by the first communication method. The group G1 is formed with the node N41 as a parent (group owner), and the nodes N42 to N43 are children (clients) thereof. Further, the group G2 is formed with the node N44 as a group owner, and the nodes N45 to N47 are clients thereof. Further, data D1 and data D2 are shared in the group G1 and the group G2, respectively. Further, the nodes N41 to the node N43 of the group G1 are moving together in a direction indicated by an arrow A1, and the nodes N44 to the node 47 of the group G2 are moving together in a direction indicated by an arrow A2 opposite to the arrow A1. Such a situation appears when three vehicles mounted with the nodes N41 to N43 of the group G1 are running in a column on a road, and four vehicles mounted with the nodes N44 to N47 of the group G2 are running in a column on a traffic lane opposite to the road, for example.

Here, a maximum number of client nodes connectable to one group owner (hereinafter, referred to as a GO) is assumed to be five for description convenience. Under such limitation, the GO node N41 of the group G1 and the GO node N44 of the group G2 of FIG. 17 are connectable to a new node. Therefore, when the group G1 is a group of a side of sending a delivery node and the group G2 is a group of a side of receiving a delivery node, for example, in a situation where any one of the client nodes N42 to N43 of the group G1 passes near the GO node N44 of the group G2, it is possible to connect the delivery node to the GO node N44 upon disconnection of the client nodes N42 to N43 as a delivery node. However, when the client nodes N42 to N 43 do not pass near the GO node N44, it is not possible to connect to the GO node N44 even when the client nodes N42 to N43 are disconnected as delivery nodes. In the present example embodiment, even in such a case, it is possible to share information using a delivery node when the GO node N41 of the group G1 passes near the GO node N44 of the group G2.

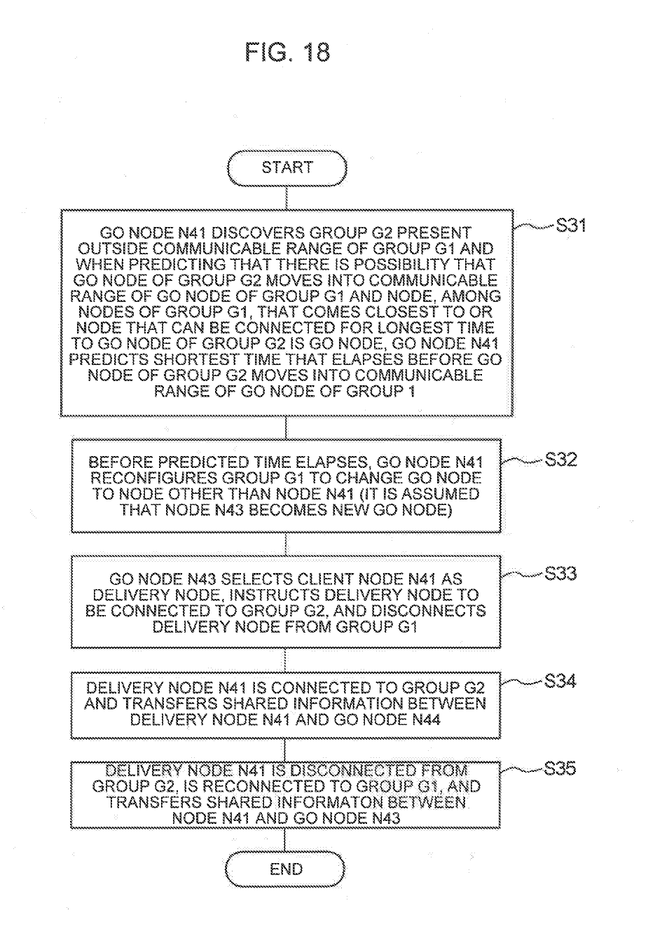

FIG. 18 is a flowchart illustrating an operation of the communication system according to the present example embodiment. Hereinafter, with reference to FIG. 18, an operation for transferring shared information between the group G1 and the group G2 in the communication system according to the present example embodiment will be described. In the present example embodiment, there is described an example in which the group G1 operates as a group of a side of sending a delivery node, and the group G2 operates as a group of a side of receiving a delivery node. However, it is also possible to send a delivery node from both groups. As a method for determining a group of a side of sending a delivery node, it is possible to use a method for determining based on a magnitude of a group number or a method for determining based on a negotiation between groups, for example.

In a state where groups G1 and G2 are formed, the GO node N41 of the group G1 of a side of sending a delivery node discovers the group G2 present outside a communicable range of the group G1 defined by the first communication method. When predicting that there is a possibility in which a GO node of the group G2 moves into a communicable range of a GO node of the group G1 and a node, among nodes of the group G1, that comes closest to or a node that can be connected for a longest time to the GO node of the group G2 is the GO node, the GO node 41 predicts a shortest time that elapses before the GO node of the group G2 moves into the communicable range of the GO node of group G1 (step S31).

Next, the GO node N41 of the group G1 performs group reconfiguration before the predicted time elapses, in preparation for transferring information through a delivery node between the group G1 and the group G2. In other words, the GO node N41 of the group G1 reconfigures the group G1 to change the GO node before the predicted time elapses (step S32). Specifically, for example, the GO node 41 instructs the client node N42 to regard the node N43 as a reconnection destination to disconnect the client node N42 from the group G1, and instructs the client node N43 to regard the node N42 as a reconnection destination to disconnect the client node N43 from the group G1. Accordingly, the GO node N41 is made to be a sole owner that is not a group owner. Thereby, the group G1 is temporarily disorganized. Thereafter, the nodes N42 to N43 are connected to each other in accordance with the instructions, and any one of the nodes becomes a GO node and the other becomes a client node to configure a group G1. The node N41 is connected to the GO node of the formed group G1 and becomes a client node of the group G1. As illustrated in FIG. 17, it is assumed that the node N43 has become a new GO node.

The node N43 having become the new GO node selects, as a delivery node, the client node N41 that is originally a GO node, and instructs the delivery node to be connected to the group G2 and to be disconnected from the group G1 (step S33). As a method for selecting the node N41 as a delivery node, there is a method in which the client node N41 requests the GO node N43 to cause the node N41 to be a delivery node, when the client node N41 is connected to the GO node N43. Alternatively, there is a method in which after group reconfiguration, the GO node N43 detects and determines that a client node that comes closest to or a client node that can be connected over a longest time to the GO node N44 becomes the node N41. Note that the disconnection of the delivery node N41 may be completed before the groups G1 and G2 approach each other at a maximum communicable distance or less defined by the first communication method or may be completed after the approach.

When discovering the GO node N44 of the group 2 by a Device Discovery procedure of the Wi-Fi Direct specification, for example, the delivery node N41 disconnected from the group G1 is connected to the GO node N44 and transfers shared information between the delivery node N41 and the GO node N44 (step S34). Specifically, the delivery node N41 transmits the data D1 to the GO node N44, and the GO node N44 transmits the data D2 to the delivery node N41. Thereby, the GO node N44 of the group G2 can acquire the data D1 shared in the group G1. Moreover, the data D1 is further transferred from the GO node N44 to the client nodes N45 to N47, and thereby the client nodes N45 to N47 can acquire the data D1 shared in the group G1.

Thereafter, the delivery node N41 is disconnected from the group G2 and is reconnected to the GO node N43 of the group G1, and thereby transfers information between the node N41 and the GO node N43 (step S35). Specifically, the delivery node N41 transmits the data D2 to the GO node N43. Thereby, the GO node N43 of the group G1 can acquire the data D2 shared in the group G2. Further, the data D2 is further transferred from the GO node N43 to the client node N42, and thereby the client node N42 can acquire the data D2 shared in the group G2.

In this manner, shared information can be transmitted between the group G1 and the group G2 via the delivery node N41.

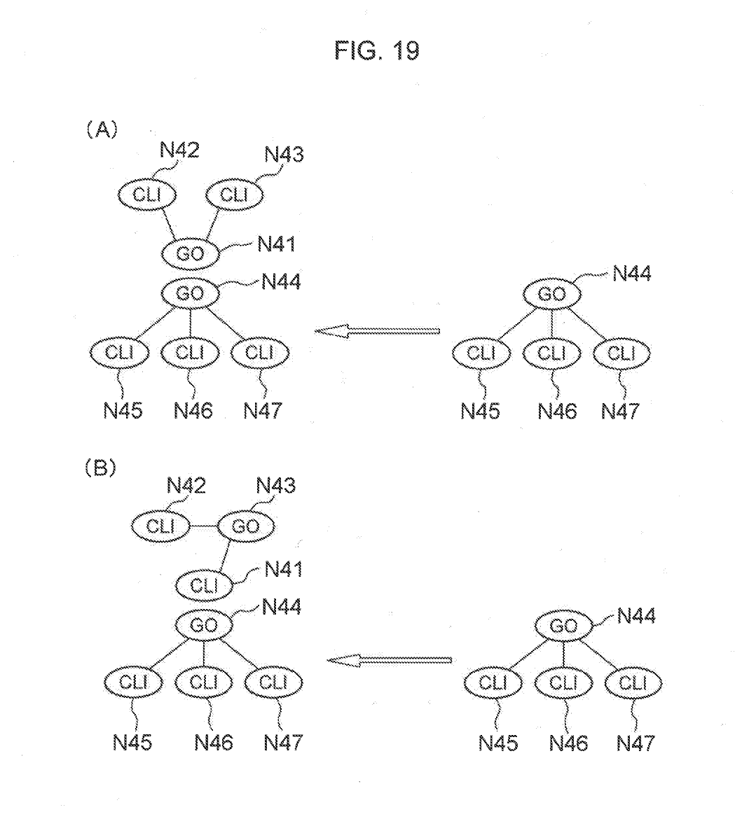

FIG. 19 visually illustrates an influence on information sharing by a delivery node caused by reconfiguration of the group G1. In a case of FIG. 19(A) in which the group G1 is not reconfigured, all the client nodes N42 to N43 of the group G1 of a side of sending a delivery node distantly pass the GO node N44 of the group G2. Therefore, it is not possible for the client nodes N42 to N43 to be connected to the GO node N44 of the group G2 even by being disconnected as a delivery node. On the other hand, in a case of FIG. 19(B) in which the group G1 is reconfigured, the client node N41 (the GO node before reconfiguration) of the group G1 after reconfiguration of a side of sending a delivery node approaches and passes the GO node N44 of the group G2. Therefore, the client node N41 can be connected to the GO node N44 of the group G2 by being disconnected as a delivery node.

Hereinafter, the configuration and operation of the communication system according to the present example embodiment will be descried in more detail.

The node N used as the nodes N41 to N47 is basically the same as the node N described with reference to FIG. 3 except that functions of the automatic connection control unit 60C differ. Further, among the functions of the automatic connection control unit 60C of the node N used as the nodes N41 to N47, functions of connection and disconnection of Wi-Fi Direct are the same as in the node N described with reference to FIG. 3. Among the functions of the automatic connection control unit 60C of the node N used as the nodes N41 to N47, a control function relating to information sharing described with reference to FIG. 18 will be described.

### <Control Function Relating to Information Sharing>

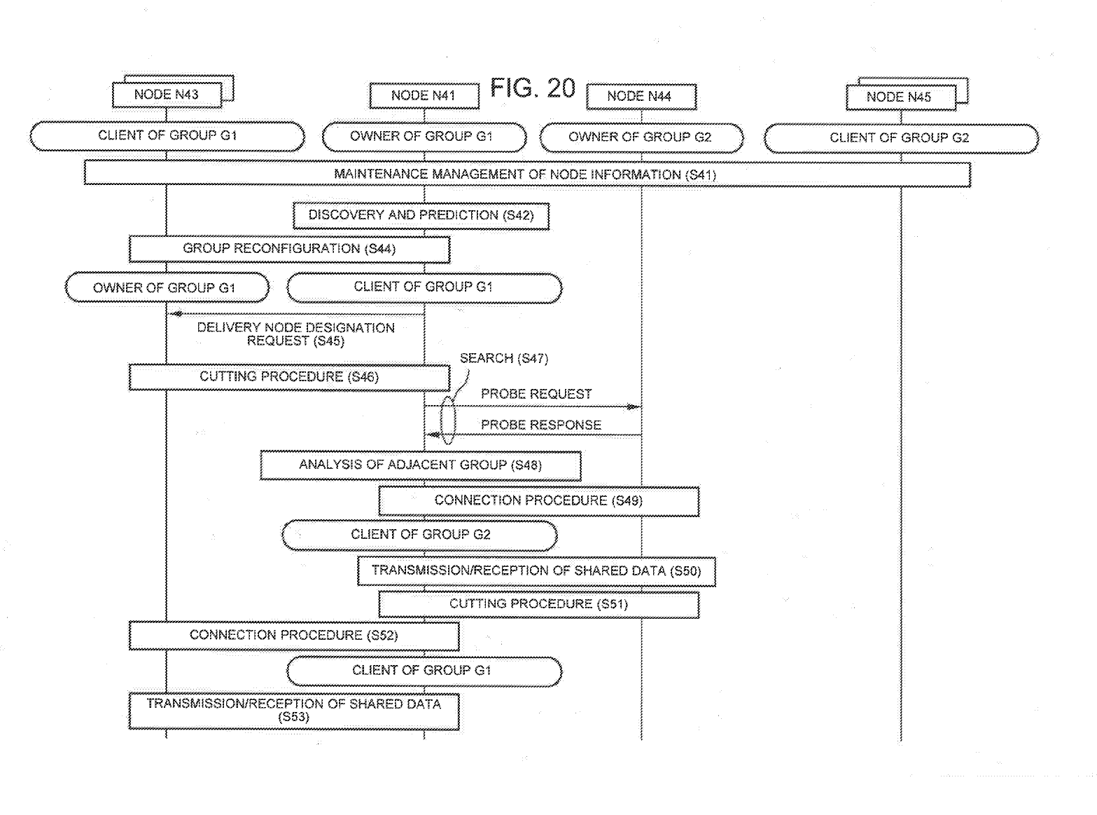

FIG. 20 is a flowchart illustrating an operation of the node N according to the present example embodiment. With reference to FIG. 20, an operation of the node N upon sharing information between the group G1 and the group G2 will be described.

In a state where groups G1 and G2 as illustrated in FIG. 17 are formed, the automatic connection control units of the nodes N41 to N47 of the groups G1 and G2 transmit/receive a position-information notification message to/from another node at a constant cycle by cellular communication. Thereby, the automatic connection control units maintain contents of the node information 50D illustrated in FIG. 6 in the latest state (S41). The operation of step S41 is the same as the operation of step S11 of FIG. 14.

The automatic connection control unit of the GO node N41 of the group G1 of a side of sending a delivery node discovers the group G2 that is approaching the group G1 based on the latest node information 50D. When predicting that there is a possibility in which a GO node of the group G2 moves into a communicable range of a GO node of the group G1 and a node, among the nodes of the group G1, that comes closest to or a node that can be connected for a longest time to the GO node of the group G2 is a GO node, the automatic connection control unit predicts a shortest time that elapses before the GO node of the group G2 moves into the communicable range of the GO node of the group G1 (S42). The operation of step S42 is executed by replacing the client nodes N12 to N15 of the center of FIG. 15 with the respective nodes of the group G1 and by executing the processing described with reference to FIG. 15.

Next, when predicting the shortest time that elapses before the GO node of the group G2 moves into the communicable range of the GO node of the group G1, the automatic connection control unit of the GO node N41 reconfigures the group G1 before the shortest time elapses (S44). By the reconfiguration of the group G1, the GO node N41 becomes a client node of the group G1 and the client node N43 becomes a GO node in FIG. 20.

Next, the client node N41 requests the GO node N43 to disconnect the node N41 as a delivery node (S45). The GO node N43 disconnects the client node N41 as a delivery node in accordance with this request (S46).

The automatic connection control unit of the delivery node N41 disconnected from the group G1 searches a neighboring group. This search is performed in conformity to a Device Discovery procedure of the Wi-Fi Direct specification. For example, in FIG. 20, the client node N41 transmits a probe request for Device Discovery processing, receives a probe response from an adjacent group G2 (S47), and thereby discovers the GO node N44 of the group G2. When discovering the GO node N44 of the group G2, the automatic connection control unit of the client node N41 analyzes the adjacent group (S48). In this analysis, it is determined whether the adjacent group is the GO node of the group G2 discovered in step S42. This determination is performed by researching whether a MAC address that is information for identifying the GO node N44 included in a probe request or a probe response transmitted from the GO node N44 of the group 2 is matched with a MAC address of the GO node of the group G2 discovered in step S42, for example. When the MAC addresses are matched, it is determined that the group is connectable. When the MAC addresses are not matched, it is determined that the group is unconnectable and the automatic connection control unit continues to search another group.

When discovering the GO node N44 of the group G2, the automatic connection control unit of the delivery node N41 executes a connection procedure between the automatic connection control unit of the delivery node N41 and the automatic connection control unit of the GO node N44 (S49). Thereby, the delivery node N41 becomes a client node.

The delivery node N41 having become a client of the group G2 transfers shared information between the delivery node N41 and the GO node N44 (S50). Specifically, the automatic connection control unit of the delivery node N41 transmits the shared information 50A (data D1) on the storage unit to the GO node N44 using the Wi-Fi connection control unit 60A. The automatic connection control unit of the GO node N44 receives the shared information 50A (data D1) from the delivery node N41 using the Wi-Fi connection control unit 60A and stores the received information on the storage unit 50. Inversely, the automatic connection control unit of the GO node N44 transmits the shared information 50A (data D2) on the storage unit to the delivery node N41 using the Wi-Fi connection control unit 60A. The automatic connection control unit of the delivery node N41 receives the shared information 50A (data D2) from the GO node N44 using the Wi-Fi connection control unit 60A and stores the received information on the storage unit 50. Thereafter, although not illustrated in FIG. 20, the data D1 is transferred from the GO node N44 to the client nodes N45 to N47 being connected.

Subsequently, the delivery node N41 is first disconnected from the group G2 when a condition for reconnection to the group G1 is satisfied (S51). The delivery node N41 is then reconnected to the GO node N43 of the group G1 (S52). The delivery node N41 again having become a client of the group G1 transfers shared information between the client node N41 and the GO node N43 (S53). Thereafter, although not illustrated in FIG. 20, the data D2 is transferred from the GO node N43 to the client node N42 being connected.

In this manner, the present example embodiment transmits shared information between groups.

### Third Example Embodiment

In the present example embodiment, one group is disorganized, and each of the nodes having become a sole node is connected to the other group as a delivery node, whereby information is transferred through the delivery node.

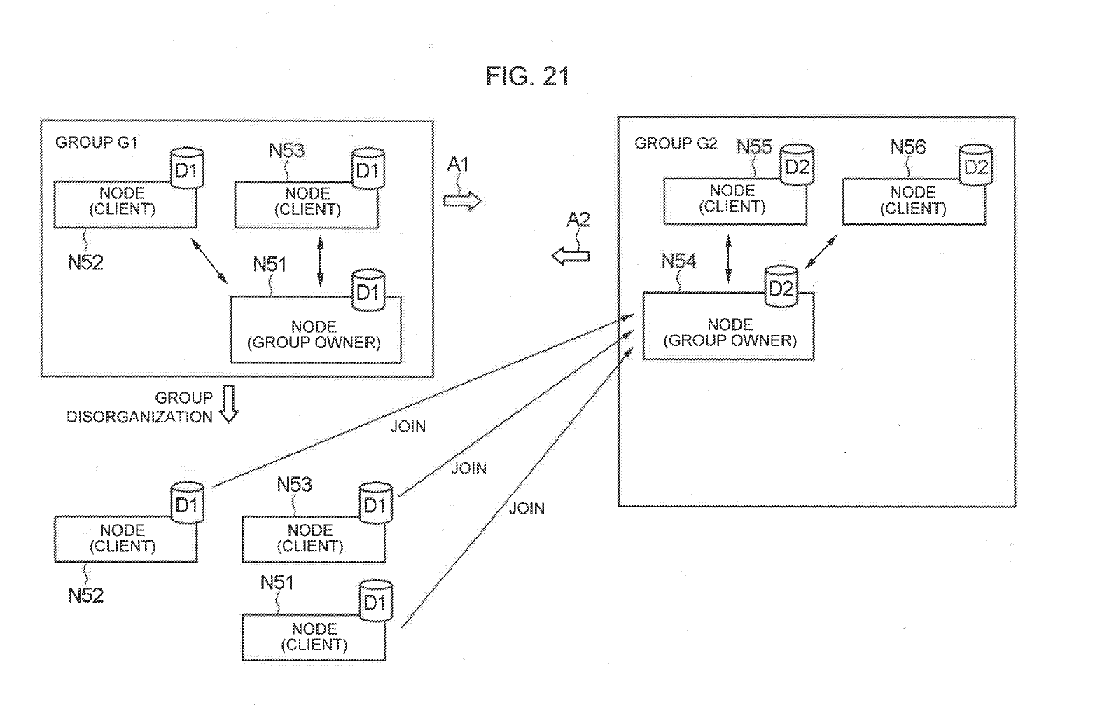

Referring to FIG. 21, a communication system according to a third example embodiment of the present invention is configured by a plurality of nodes N51 to N56. Each of the nodes N51 to N56 is a mobile wireless terminal mounted on a vehicle such as an automobile. Each of the nodes N51 to N56 is capable of performing wireless communication using a first communication method that can form a Peer-to-Peer group and wireless communication using a second communication method different therefrom. The first communication method is Wi-Fi Direct, for example, and the second communication method is cellular communication such as 3G and LTE. Note that the first communication method is not limited to Wi-Fi Direct when being a communication method capable of forming a Peer-to-Peer group with another wireless terminal. Further, the second communication method is not limited to cellular communication when being a wireless communication method capable of performing longer-distance communication than the first communication method.

In FIG. 21, a plurality of nodes N51 to N56 configure two Peer-to-Peer groups G1 and G2 (hereinafter, simply referred to as groups) by the first communication method. The group G1 is formed with the node N51 as a parent (group owner), and the nodes N52 to N53 are children (clients) thereof. Further, the group G2 is formed with the node N54 as a group owner, and the nodes N55 to N56 are clients thereof. Still further, data D1 and data D2 are shared in the group G1 and the group G2, respectively. Moreover, the nodes N51 to N53 of the group G1 are moving together in a direction indicated by an arrow A1, and the node N54 to N56 of the group G2 are moving together in a direction indicated by an arrow A2 opposite to the arrow A1. Such a situation appears when three vehicles mounted with the nodes N51 to N53 of the group G1 are running in a column on a road, and three vehicles mounted with the nodes N54 to N56 of the group G2 are running in a column on a traffic lane opposite to the road, for example.

Here, a maximum number of client nodes connectable to one group owner (hereinafter, referred to as a GO) is assumed to be five for description convenience. Under such limitation, the GO node N51 of the group G1 and the GO node N54 of the group G2 of FIG. 21 can be further connected to three new nodes, respectively. This means that the groups G1 and G2 can be integrated into one group. Therefore, in the present example embodiment, all nodes belonging to any one of the groups G1 and G2 are set as a delivery node, and thereby data sharing between the groups G1 and G2 is achieved. As a method for determining a group of a side of sending a delivery node, it is possible to use a method for determining based on a magnitude of a group number or a method for determining based on a negotiation between groups, for example. The following will describe an example in which the group G1 operates as a group of a side of sending a delivery node and the group G2 operates as a group of a side of receiving a delivery node.

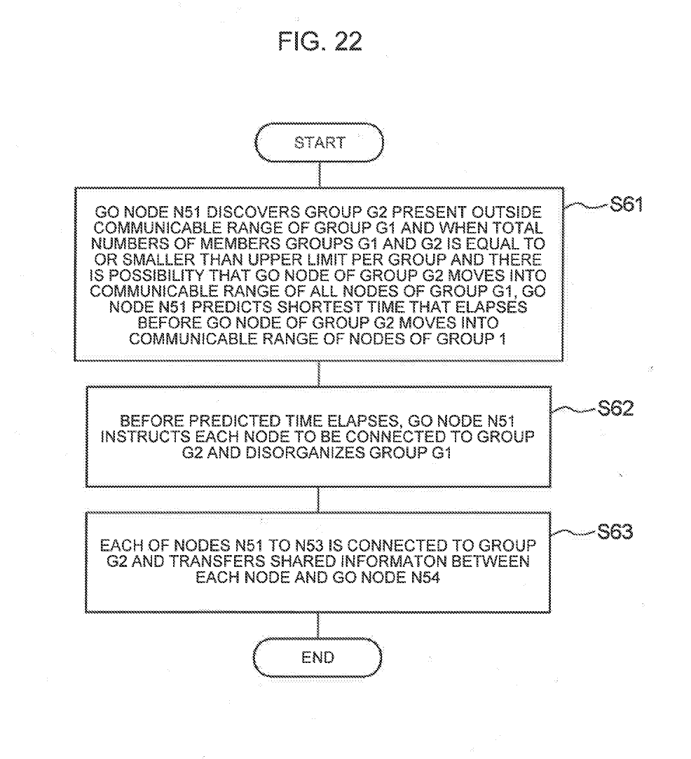

FIG. 22 is a flowchart illustrating an operation of the communication system according to the present example embodiment. With reference to FIG. 22, operations for transferring shared information between the group G1 and the group G2 in the communication system according to the present example embodiment will be described.

In a state where groups G1 and G2 are formed as illustrated in FIG. 21, the GO node N51 of the group G1 of a side of sending a delivery node discovers the group G2 present outside a communicable range of the group G1 defined by the first communication method. When there is a possibility in which the total numbers of members of the groups G1 and G2 is equal to or smaller than an upper-limit number per group and the GO node N 54 of the group G2 moves to the communicable range defined by the first communication method of all the nodes N51 to N53 of the group G1, the GO node N51 predicts a shortest time necessary for the GO node N54 to move into the communicable range of the nodes N51 to N53 of the group G1 (step S61).

Next, the GO node N15 of the group G1 performs group reconfiguration before the predicted time elapses, in preparation for transferring information through a delivery node between the group G1 and the group G2. In other words, before the predicted time elapses, the GO node N51 of the group G1 instructs each of the nodes N51 to N53 to be connected to the group G2 as a delivery node and disorganizes the group G1 (S62). Specifically, the GO node N51 disconnects the client nodes N52 and N53 from the group G1 and then makes the node N51 to be a sole node that is not a group owner, for example.

Next, when discovering the GO node N54 of the group G2, for example, the nodes N51 to N 53 are connected to the GO node N54 by a Device Discovery procedure of the Wi-Fi Direct specification, and transfer shared information between the nodes N51 to N 53 and the GO node N54 (step S63). Specifically, any one of the nodes N51 to N53 transmits the data D1 to the GO node N54, and the GO node N54 transmits the data D2 to the nodes N51 to N53. Thereby, the GO node N54 of the group G2 can acquire the data D1 shared in the group G1, and the nodes N51 to N53 can acquire the data D2 shared in the group G2. Moreover, the data D1 is further transferred from the GO node N54 to the client nodes N55 to N56, and thereby the client nodes N55 to N56 can acquire the data D1 shared in the group G1.

Operations of the nodes N51 to N53 thereafter are optional. When moving thereafter in the same direction as the GO node N54, the nodes N51 to N53 may remain in the group G2, for example. Alternatively, when moving in a direction different from the GO node N54, the nodes N51 to N53 may be disconnected from the group G2 and then connected to each other to form the same group G1 again.

In this manner, all the nodes N51 to N53 of the group G1 become a delivery node, and thereby shared information can be transmitted between the group G1 and the group G2.

Hereinafter, the configuration and operation of the communication system according to the present example embodiment will be described in more detail.

The node N used as the node N51 to N56 is basically the same as the node N described with reference to FIG. 3 except that functions of the automatic connection control unit 60C differ. Further, among the functions of the automatic connection control unit 60C of the node N used as the nodes N51 to N56, functions of connection and disconnection of Wi-Fi Direct are the same as in the node N described with reference to FIG. 3. Among the functions of the automatic connection control unit 60C of the node N used as the nodes N51 to N56, the following will describe a control function relating to information sharing described with reference to FIG. 22.

### <Control Function Relating to Information Sharing>

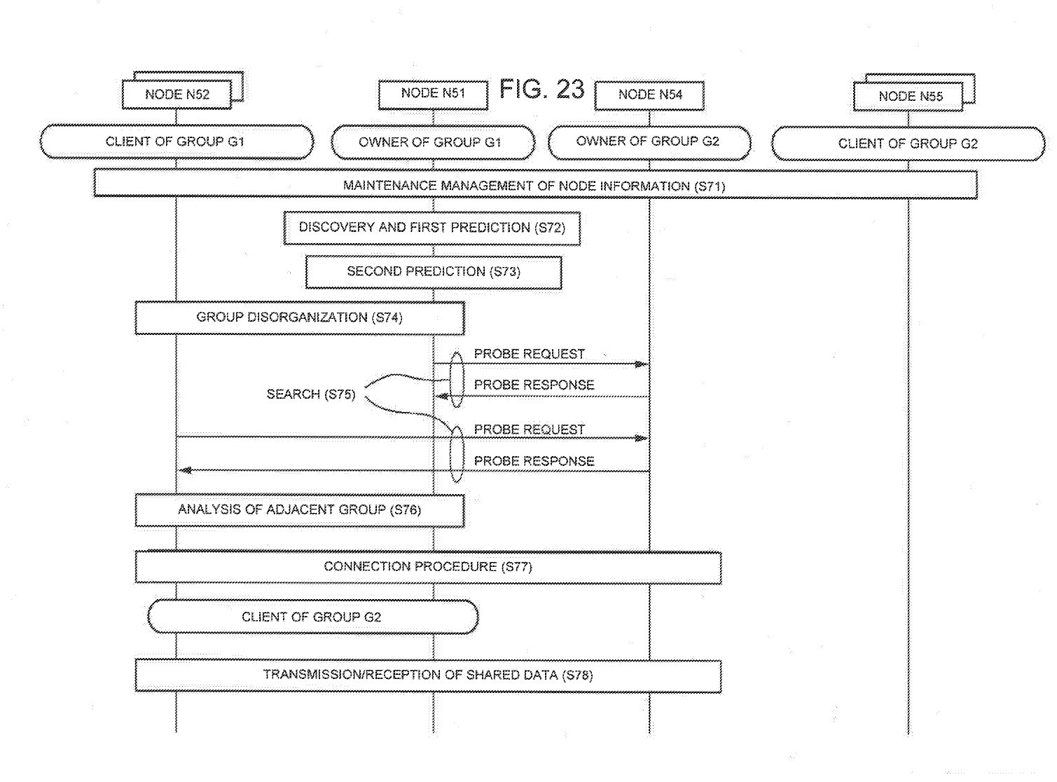

FIG. 23 is a flowchart illustrating an operation of the node N according to the present example embodiment. With reference to FIG. 23, the following will describe an operation of the node N upon sharing information between the group G1 and the group G2.

In a state where groups G1 and G2 as illustrated in FIG. 21 are formed, the automatic connection control units of the nodes N51 to N56 of the groups G1 and G2 transmit/receive a position-information notification message to/from another node at a constant cycle by cellular communication. Thereby, the automatic connection control units maintain contents of the node information 50D illustrated in FIG. 6 in the latest state (S71). The operation of step S71 is the same as the operation of step S11 of FIG. 14.

The automatic connection control unit of the GO node N51 of the group G1 of a side of sending a delivery node discovers a group that is approaching the group G1 based on the latest node information 50D. Further, the automatic connection control unit predicts a shortest time that elapses before the discovered group moves to a predetermined range (S72). The operation of step S72 is the same as the operation of step S12 of FIG. 14.

Subsequently, the automatic connection control unit of the GO node N41 discovers the group G2 that is approaching the group G1 by the operation of step S72. When determining that the GO node N54 of the group G2 moves to a region W1 of the client nodes N52 to N53 of the group G1, the automatic connection control unit predicts whether a total of the numbers of the members of the groups G1 and G2 is equal to or smaller than an upper limit of the number of the members of one group and a shortest time that elapses before the GO node N54 of the group G2 moves to a region W1 of the GO node N51 of the group G1 (step S73). The prediction processing of the shortest time can be carried out using the GO node N51 instead of the client nodes N12 to N16 in the operation of step S12 of FIG. 14. Further, the total number of members of the groups G1 and G2 can be obtained by adding a number of nodes of the group G1 managed by the group information 50C and a number of nodes belonging to the discovered group G2, for example.

Moreover, the automatic connection control unit of the GO node N51 of the group G1 calculates that there is a possibility in which the GO node N54 of the group G2 moves to the region W1 of the GO node N51 of the group G1, and calculates a shortest time that elapses before the GO node N54 moves to the region W1. The automatic connection control unit performs disorganization of the group G1 before a shorter time of the above-calculated shortest time and the shortest time calculated in step S72 elapses (S74). By this disorganization of the group G1, the GO node N51 and the client nodes N52 to N53 become sole nodes, respectively. Before the disorganization, the GO node N51 designates, for the client nodes N51 to N53, information of a connection destination as a delivery node such as a group identifier of the group G2 or a MAC address of the GO node N54.

The automatic connection control units of the nodes N51 to N53 having become sole nodes search a neighboring group. This search is performed in conformity to a Device Discovery procedure of the Wi-Fi Direct specification. In FIG. 23, N51 to N53 transmit a probe request for Device Discovery processing, receive a probe response from an adjacent group G2 (S75), and thereby discover the GO node N54 of the group G2. When discovering the GO node N54 of the group G2, the automatic connection control units of the nodes N51 to N53 analyze the adjacent group (S76). In this analysis, it is determined whether the adjacent group is a GO node of the group G2 to be connected as a delivery node. This determination is performed by researching whether a MAC address that is information for identifying the GO node N54 included in a probe request or a probe response transmitted from the GO node N54 of the group G2 is matched with a MAC address of the GO node of the group G2 designated for connection as a delivery node before the group disorganization, for example. When the MAC addresses are matched, it is determined that the group is connectable. When the MAC addresses are not matched, it is determined that the group is unconnectable and the automatic connection control unit continues to search another group.

When discovering the GO node N54 of the group G2, the automatic connection control unit of each of the nodes N51 to N53 executes a connection procedure between the own unit and the automatic connection control unit of the GO node N54 (S77). Thereby, the nodes N51 to N53 become client nodes of the group G2, respectively.

The nodes N51 to N53 having become the client nodes of the group G2 transfer shared information between the nodes N51 to N53 and the GO node N54 (S78). Specifically, the automatic connection control unit of the node N51 transmits the shared information 50A (data D1) on the storage unit to the GO node N54 using the Wi-Fi connection control unit 60A, for example. The automatic connection control unit of the GO node N54 receives the shared information 50A (data D1) from the node N51 using the Wi-Fi connection control unit 60A, and stores the received information on the storage unit 50. Further, the automatic connection control unit of the GO node N54 transmits the shared information 50A (data D2) on the storage unit to the nodes N51 to N53 using the Wi-Fi connection control unit 60A. The automatic connection control units of the nodes N51 to N53 receive the shared information 50A (data D2) from the GO node N54 using the Wi-Fi connection control unit 60A, and stores the received information on the storage unit 50. Further, the data D1 is transferred from the GO node N54 to the client nodes N55 to N56 being connected.

In this manner, the present example embodiment transmits shared information between groups.

As a modified example of the present example embodiment, a configuration in which the GO node N54 of the group G2 executes the same steps S72 and S73 as in the GO node N51 of the group G1 is conceivable. In this case, before disorganization of each group, the GO node N51 of the group G1 and the GO node N54 of the group G2 may negotiate group disorganization using communication by the second communication method with a GO node of a partner group to determine whether to disorganize any one of the groups. Alternatively, before disorganization of each group, the GO node N51 of the group G1 and the GO node N54 of the group G2 may determine which one of the groups to disorganize based on a magnitude of a group number, for example.

### Other Example Embodiments

The present invention is not limited to the above-described example embodiments and can be subjected to various other types of additions/modifications. For example, example embodiments as described below are included in the present invention.

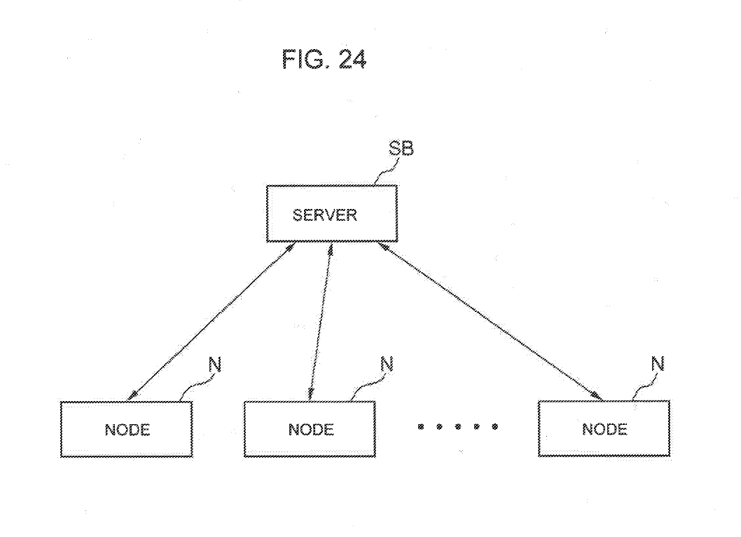

In the above-described example embodiments, the automatic connection control unit 60C of the node N directly transmitted/received a position-information notification message to/from another node. However, a position-information notification message may be transmitted/received among nodes via a server SB as illustrated in FIG. 24, for example. At that time, the automatic connection control unit 60C of each node N transmits a position-information notification message to the server SB at a constant cycle by cellular communication using the cellular communication control unit 60B. The server SB stores node information (hereinafter, referred to as server-side node information) similar to the node information 50D. When an entry including a node identifier or a MAC address matched with a node identifier or a MAC address in the received position-information notification does not exist in the server-side node information, the server SB stores the received position-information notification message in a new entry, and adds the stored message to the server-side node information. When such entry exists, the server SB overwrites the existing entry by the received position-information notification message. Further, the automatic connection control unit 60C of each node N downloads server-side node information from the server SB at a constant cycle by cellular communication using the cellular communication control unit 60B, and stores the downloaded information on the storage unit 50 as the node information 50D.

Further, in the above-described example embodiments, the automatic connection control unit 60C of the node N predicts the presence or absence of a possibility in which a discovered group moves to a predetermined range of the group of node N and a shortest time that elapses before the movement thereto based on a position and a velocity (a moving direction and a speed) of a node. However, other pieces of information may be exchanged between nodes by a position-information notification message to be used for the prediction. For example, the automatic connection control unit 60C of the node N may use information detected or managed by a car navigation system installed in a vehicle mounted with the node N. Thereby, the automatic connection control unit 60C may predict the presence or absence of a possibility in which a discovered group moves to a predetermined range of the group of node N and a shortest time that elapses before the movement thereto. As an example of the usable information, there is route information estimated from a curvature of a curve of a currently-running road or a destination.

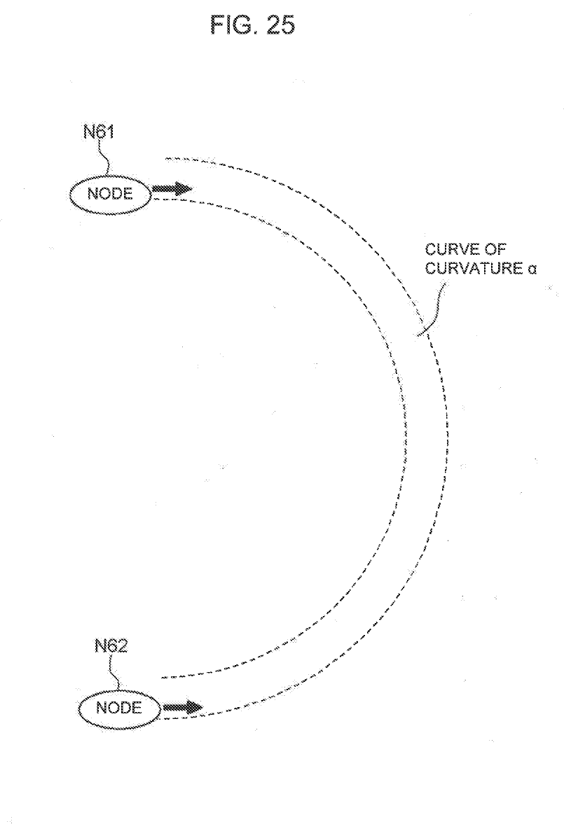

FIG. 25 illustrates an example in which prediction is performed using a curvature of a currently-running road. A node N 61 belonging to the group G1 is running in an arrow direction along a curve of a road of a curvature a, and a node N62 belonging to the group G2 is running in an arrow direction on an opposite traffic lane of the same curve. In such a case, it is difficult to predict whether the nodes approach each other, by only using current positions and moving velocities of the nodes N61 and N62. However, when currently-running curvatures are considered, moving routes of the node N61 and the node N62 can be predicted as illustrated with dashed lines in FIG. 25. Therefore, it is possible to predict a possibility accurately in which one node N61 moves to a predetermined range of the other node N62 and a shortest time necessary for the movement thereto.

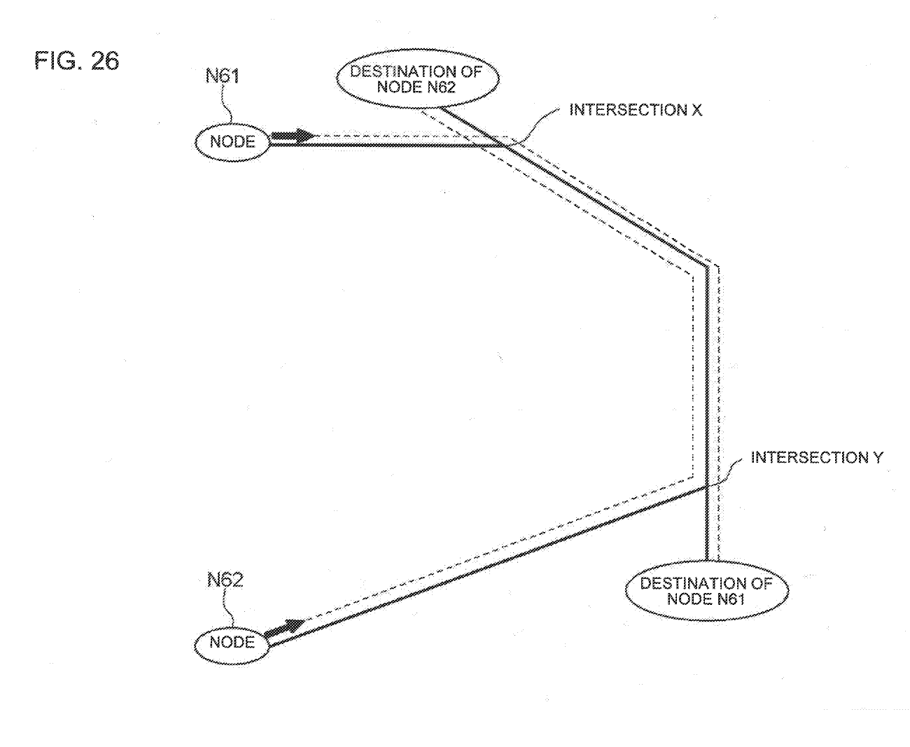

FIG. 26 illustrates an example in which prediction is performed using a route estimated from a destination. In FIG. 26, a dashed line extending from a node N61 to a destination thereof is a moving route derived by a car navigation system from a current position of the node N61 and a destination thereof. In the same manner, a dashed line extending from a node N62 to a destination thereof is a moving route derived by a car navigation system from a current position of the node N62 and a destination thereof. The moving routes of the nodes N61 and N62 are partially overlapped. Accordingly, it is possible to accurately predict a possibility in which one node N61 moves to a predetermined range of the other node N62 and a shortest time necessary for the movement thereto, based on a current position, a velocity, and a moving route of the node N61 and a current position, a velocity, and a moving route of the node N62.

It should be noted that the present invention is based upon and claims the benefit of priority from Japanese patent application No. 2014-264496, filed on Dec. 26, 2014, and the contents described in the patent application are incorporated herein in its entirety.

### INDUSTRIAL APPLICABILITY

The present invention is applicable to a P2P network including a plurality of nodes (wireless terminals) that can dynamically form a group.

### REFERENCE SIGNS LIST

G1 to G2 . . . Group
GO . . . Group owner
N . . . Node
D . . . Data
10, 20 . . . Wireless communication I/F unit
30 . . . Operation input unit
40 . . . Screen display unit
50 . . . Storage unit
50A . . . Shared information
50B . . . Connection node list
50C . . . Group information
50D . . . Node information
50P . . . Program
60 . . . Processing unit
60A Wi-Fi connection control unit
60B . . . Cellular communication control unit
60C . . . Automatic connection control unit
70 . . . GPS

1. (canceled)

2. A communication system in a wireless communication network including a plurality of nodes that each capable of performing wireless communication by a first communication method that can form a Peer-to-Peer group and wireless communication by a second communication method, the communication system comprising:
a first Peer-to-Peer group including a first owner node that operates as an access point and a client node; and
a second Peer-to-Peer group including a second owner node that operates as an access point and a client node, wherein
the first owner node discovers the second Peer-to-Peer group present in a second communicable range that is a region outside a first communicable range defined by the first communication method using the wireless communication by the second communication method, predicts a time that elapses before the second Peer-to-Peer group moves into the first communicable range, and performs group reconfiguration before the time predicted elapses.

3. A wireless terminal comprising:
a first wireless communication unit configured to perform a first communication method that can form a Peer-to-Peer group with another wireless terminal;
a second wireless communication unit configured to perform a second communication method; and
an automatic connection controller, wherein
the automatic connection controller includes, when operating as an access point of a first Peer-to-Peer group, a first function of discovering a second Peer-to-Peer group present in a second communicable range that is a region outside a first communicable range defined by the first wireless communication unit using the second wireless communication unit, a second function of predicting a time that elapses before the second Peer-to-Peer group moves into the first communicable range, and a third function of performing group reconfiguration before the time predicted elapses.

4. The wireless terminal according to claim 3, wherein
the automatic connection controller selects one or a plurality of client nodes belonging to the first Peer-to-Peer group as a delivery node, instructs the delivery node selected to be connected to the second Peer-to-Peer group, and disconnects the delivery node from the first Peer-to-Peer group, in the group reconfiguration.

5. The wireless terminal according to claim 4, wherein
the automatic connection controller reconnects the delivery node disconnected from the second Peer-to-Peer group after being connected to the second Peer-to-Peer group to the first Peer-to-Peer group.

6. The wireless terminal according to claim 4, wherein
the automatic connection controller predicts a shortest distance where a client node belonging to the first Peer-to-Peer group and a node that operates as an access point of the second Peer-to-Peer group approach each other, and determines the delivery node based on the shortest distance predicted.

7. The wireless terminal according to claim 4, wherein
the automatic connection controller predicts a time length when a client node belonging to the first Peer-to-Peer group and a node that operates as an access point of the second Peer-to-Peer group approach each other at a predetermined distance or less defined by the first wireless communication method, and determines the delivery node based on the time length predicted.

8. The wireless terminal according to claim 3, wherein
the automatic connection controller temporarily disconnects one or a plurality of client nodes belonging to the first Peer-to-Peer group, in the group reconfiguration.

9. The wireless terminal according to claim 8, wherein
the automatic connection controller connects, to the first Peer-to-Peer group, a delivery node that moves into the first communicable range by being disconnected from the second Peer-to-Peer group.

10. The wireless terminal according to claim 8, wherein
the automatic connection controller performs the temporal disconnection of one or a plurality of client nodes only when a number of connection clients of the first Peer-to-Peer group reaches an upper limit.

11. The wireless terminal according to claim 8, wherein
the automatic connection controller reconnects the client node disconnected to the first Peer-to-Peer group when a special condition occurs.

12. The wireless terminal according to claim 11, wherein
the special condition includes that a certain time elapses after the client node is disconnected.

13. The wireless terminal according to claim 11, wherein
the special condition includes that a number of terminals of the first Peer-to-Peer group increases once and then decreases again after the client node is disconnected.

14. The wireless terminal according to claim 3, wherein
the automatic connection controller disorganizes the first Peer-to-Peer group after instructing a node belonging to the first Peer-to-Peer group to be connected to the second Peer-to-Peer group, in the group reconfiguration.

15. The wireless terminal according to claim 14, wherein
the automatic connection controller performs the disorganization of the first Peer-to-Peer group only when a total of a number of members of the first Peer-to-Peer group and a number of members of the second Peer-to-Peer group is equal to or smaller than a predetermined maximum number of members in one Peer-to-Peer group.

16. The wireless terminal according to claim 14, wherein
the automatic connection controller performs the disorganization of the first Peer-to-Peer group only when there is a possibility that a node that operates as an access point of the second Peer-to-Peer group moves into a communicable range defined by the first communication method of all nodes of the first Peer-to-Peer group.

17. The wireless terminal according to claim 14, wherein
the automatic connection controller determines which one of the first Peer-to-Peer group and the second Peer-to-Peer group to disorganize by negotiating with a group owner of the second Peer-to-Peer group through the second wireless communication unit.

18. (canceled)

19. The wireless terminal according to claim 3, wherein
the automatic connection controller reconfigures the first Peer-to-Peer group in such a way that a node other than an own-node becomes an owner node that operates as an access point and the own-node becomes a delivery node, in the group reconfiguration.

20. The wireless terminal according to claim 19, wherein
the automatic connection controller performs the reconfiguration of the first Peer-to-Peer group only when predicting that a node that comes closest to a group owner of the second Peer-to-Peer group is an own-node among nodes belonging to the first Peer-to-Peer group.

21. The wireless terminal according to claim 19, wherein
the automatic connection controller performs the reconfiguration of the first Peer-to-Peer group only when predicting that a node that performs communication with a group owner of the second Peer-to-Peer group over a longest time by the first wireless communication unit is an own-node among nodes belonging to the first Peer-to-Peer group.

22. A communication control method of a wireless terminal including a first wireless communication unit by a first communication method that can form a Peer-to-Peer group with another wireless terminal and a second wireless communication unit by a second communication method, the communication control method comprising:
discovering a second Peer-to-Peer group present in a second communicable range that is a region outside a first communicable range defined by the first wireless communication unit using the second wireless communication unit, when operating as an access point of a first Peer-to-Peer group;
predicting a time that elapses before the second Peer-to-Peer group moves into the first communicable range; and
performing group reconfiguration before the time predicted elapses.

23. (canceled)
